(19) United States
(12) Patent Application Publication
(10) Pub. No.: US 2026/0264419 A1
(43) Pub. Date: Sep. 10, 2026

(54) PRINTING APPARATUS

(71) Applicant: CANON KABUSHIKI KAISHA, Tokyo (JP)

(72) Inventors: RYO KOBAYASHI, Kanagawa (JP); TAKESHI KODA, Kanagawa (JP); RYUTARO TAIRA, Kanagawa (JP)

(21) Appl. No.: 19/555,158

(22) Filed: Mar. 3, 2026

(30) Foreign Application Priority Data
Mar. 4, 2025 (JP) 2025-034027

(51) Int. Cl. B41J 11/00

(52) U.S. Cl. CPC B41J 11/00222; B41J 11/0045

(57) ABSTRACT

A printing apparatus including: a conveyance unit configured to convey a print medium on which printing was performed by a printing unit; a guide unit configured to guide the print medium conveyed by the conveyance unit; a heating unit disposed in a position opposing a guide surface of the guide unit, and configured to heat the print medium conveyed by the conveyance unit; and an adjustment unit configured to adjust a distance between the guide surface and the heating unit, wherein the guide unit includes a guide member that forms the guide surface, and the adjustment unit adjusts a position of the guide member in an approaching-separation direction in which the guide member approaches and separates from the heating unit.

### BACKGROUND

### Field of the Technology

The present disclosure relates to a printing apparatus.

### Description of the Related Art

Printing apparatuses which print images using a print medium are known. In a printing apparatus, to fix a printing agent such as ink onto a print medium, the printing agent may be heated and dried after the image has been formed on the print medium. Japanese Patent Laid-Open No. 2019-162769 discloses a technique for adjusting temperature settings of a first heating unit and a second heating unit to control a temperature difference between two sides of a conveyed object.

### SUMMARY

The present disclosure provides a technique for uniformly heating a print medium.

The present disclosure in one aspect provides a printing apparatus comprising: a conveyance unit configured to convey a print medium on which printing was performed by a printing unit; a guide unit configured to guide the print medium conveyed by the conveyance unit; a heating unit disposed in a position opposing a guide surface of the guide unit, and configured to heat the print medium conveyed by the conveyance unit; and an adjustment unit configured to adjust a distance between the guide surface and the heating unit, wherein the guide unit includes a guide member that forms the guide surface, and the adjustment unit adjusts a position of the guide member in an approaching-separation direction in which the guide member approaches and separates from the heating unit.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIGS. 1A and 1B are perspective views of a printing apparatus.

FIGS. 2A and 2B are explanatory diagrams illustrating a conveyance path of a print medium.

FIG. 3 is an explanatory diagram illustrating a discharge guide unit.

FIG. 4 is an explanatory diagram illustrating a discharge guide unit.

FIG. 5 is a cross-sectional view of a discharge guide unit.

FIG. 6 is a perspective view of an adjustment tool.

FIG. 7 is a cross-sectional view of an adjustment tool and a discharge guide unit.

FIG. 8 is a block diagram illustrating a control system of a printing apparatus.

FIG. 9 is a cross-sectional view of a discharge guide unit.

FIGS. 10A and 10B are explanatory diagrams illustrating an insulation member.

FIG. 11 is a perspective view of a heating unit.

FIG. 12 is a cross-sectional view of a heating unit.

FIG. 13 is an explanatory diagram illustrating an adjustment mechanism.

FIGS. 14A and 14B are cross-sectional views of a heating unit.

FIG. 15 is a cross-sectional view of a heating unit.

FIGS. 16A and 16B are explanatory diagrams illustrating a reinforcement member.

FIG. 17 is an explanatory diagram illustrating an adjustment mechanism.

FIG. 18 is an explanatory diagram illustrating an adjustment mechanism.

FIG. 19 is an explanatory diagram illustrating gap adjustment.

FIG. 20 is an explanatory diagram illustrating a discharge guide unit.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

With past techniques, even if temperature settings used when heating a print medium can be controlled, the amount of heat on the print medium may change depending on the distance (gap) between the heating unit and a guide surface of the print medium being conveyed, which may affect the quality of the print medium.

### First Embodiment

In the drawings referred to in the present embodiment, arrows X, Y, and Z indicate directions intersecting with one another, where the arrows X and Y indicate horizontal directions orthogonal to each other, and the arrow Z indicates the vertical direction. The X direction corresponds to the left-right direction (width direction) of a printing apparatus 100, and the Y direction corresponds to a front-rear direction (depth direction) of the printing apparatus 100. The Z direction corresponds to a height direction of the printing apparatus 100. When referring to the “downstream” side or the “upstream” side, the conveyance direction of the print medium serves as a reference.

Although the present embodiment describes a case in which the present disclosure is applied in a serial ink jet printing apparatus, the present disclosure can also be applied in printing apparatuses that use other formats. “Printing” includes not only forming information having meaning, such as text, graphics, and the like, but also broadly includes forming any image, pattern, or the like, which does or does not have meaning, on a print medium or processing the medium, regardless of whether the content is manifested in a way that can be perceived visually by humans. Additionally, although the “print medium” is assumed to be sheet-shaped paper in the present embodiment, cloth, plastic film, or the like may be used instead.

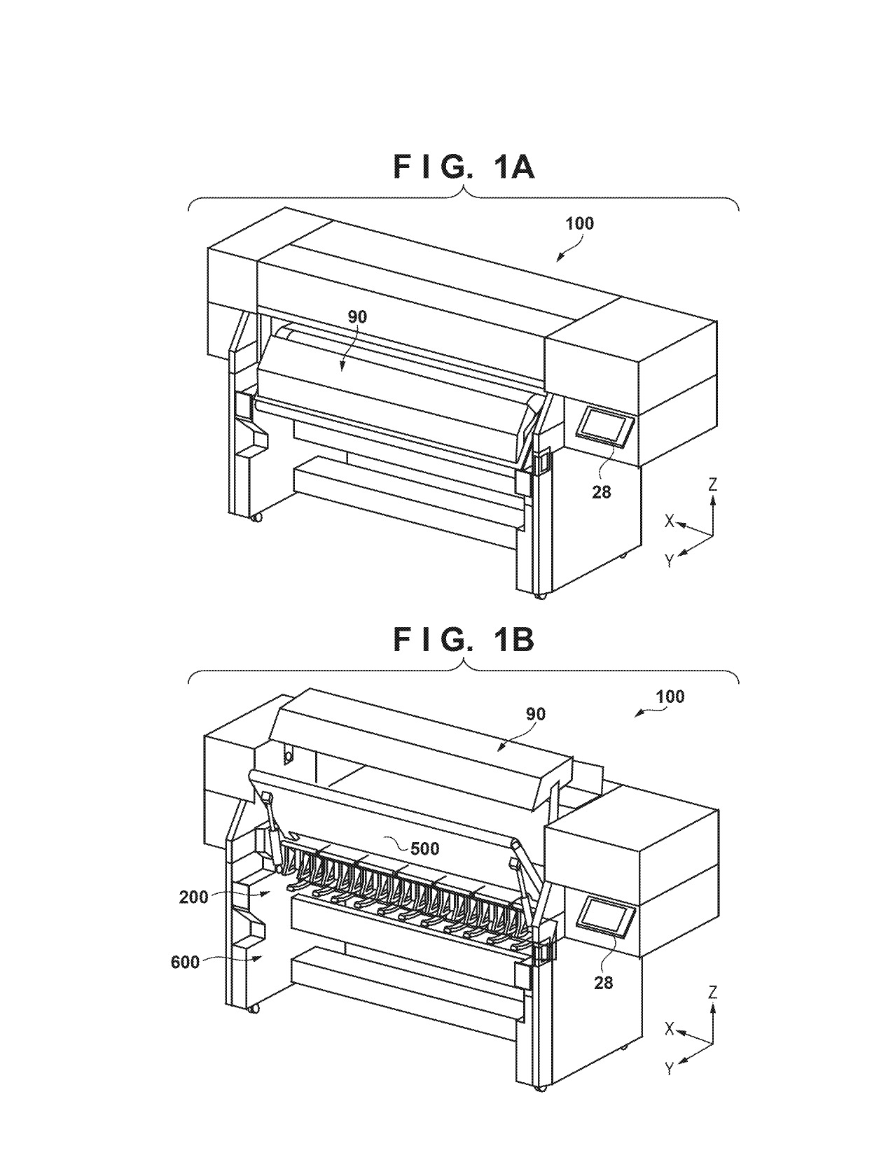

FIGS. 1A and 1B are exterior views of the printing apparatus 100 according to one embodiment of the present disclosure. A roll sheet R, in which a sheet 1 serving as the print medium is wound in roll form, can be set in the printing apparatus 100. The printing apparatus 100 includes a supply device 200 in which the roll sheet R is set and which supplies the sheet 1, a discharge guide unit 500 that guides the sheet 1, a heating unit 90 that heats the sheet 1, and a winding device 600 that winds the discharged sheet 1. The discharge guide unit 500 and the heating unit 90 are configured to be openable and closable on a front side of the printing apparatus 100.

FIG. 1A is a perspective view of the printing apparatus 100 with the discharge guide unit 500 and the heating unit 90 closed. The printing apparatus 100 executes various operations, such as printing operations and conveyance operations, with the discharge guide unit 500 and the heating unit 90 closed. FIG. 1B is a perspective view of the printing apparatus 100 with the discharge guide unit 500 and the heating unit 90 open. A user can access the supply device 200 and set the roll sheet R from the front of the printing apparatus 100 when the discharge guide unit 500 and the heating unit 90 are open.

As will be described later, an outer roll sheet R1 and an inner roll sheet R2 can be set in the supply device 200. The outer roll sheet R1 is a roll sheet R wound so that a printing surface is located on the outside in the radial direction of the roll. The inner roll sheet R2 is a roll sheet R wound so that a printing surface is located on the center side (the inside) in the radial direction of the roll.

An image is printed onto the sheet 1 selectively pulled out from the roll sheet R set in the supply device 200. A user can enter various commands to the printing apparatus 100, such as specifying the size of the sheet 1, switching between online and offline, and the like, by using various switches provided in a console 28.

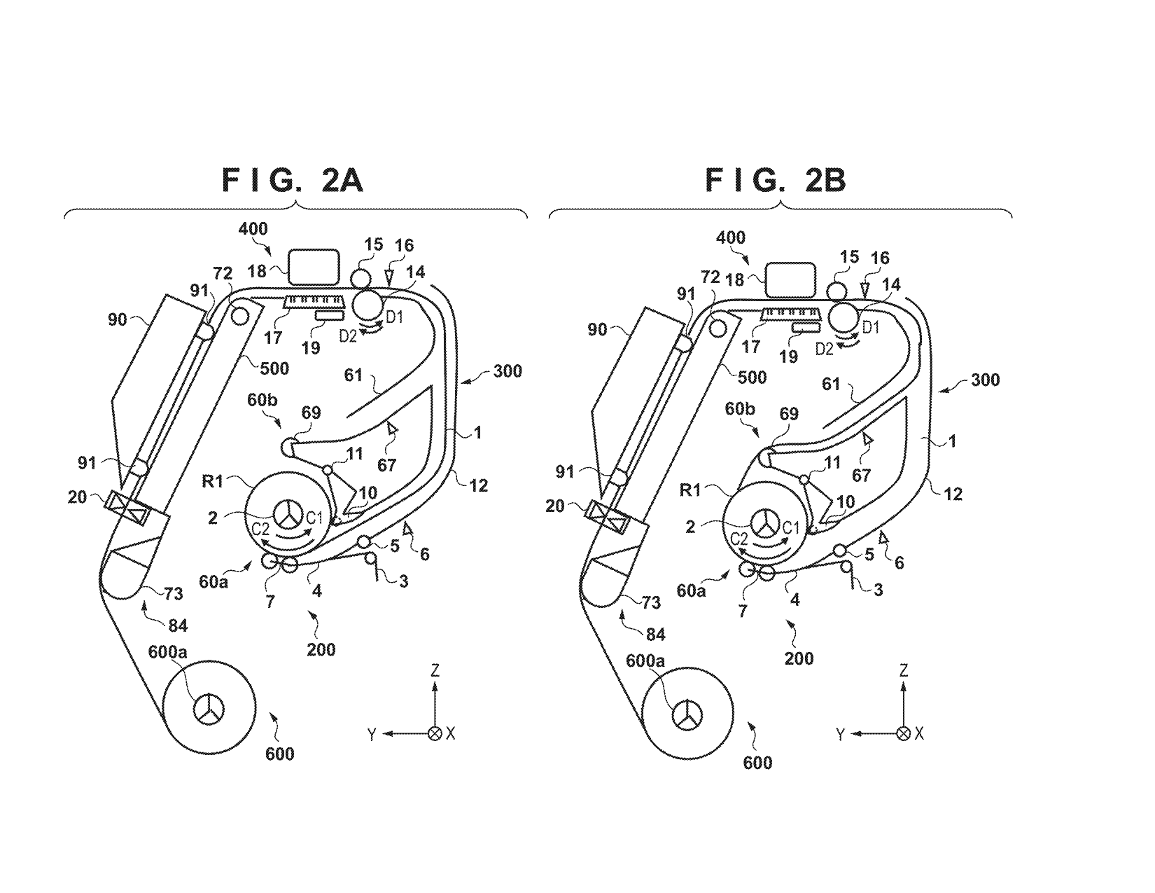

FIGS. 2A and 2B are schematic cross-sectional views of the primary elements of the printing apparatus 100. FIG. 2A illustrates a conveyance path of the sheet 1 when the outer roll sheet R1 is set in the supply device 200. FIG. 2B illustrates a conveyance path of the sheet 1 when the inner roll sheet R2 is set in the supply device 200. The supply device 200 is provided below the printing apparatus 100 in the vertical direction.

The printing apparatus 100 includes a conveyance unit 300 that conveys the sheet 1 supplied from the supply device 200 and a printing unit 400 that prints an image onto the sheet 1 conveyed from the conveyance unit 300. The sheet 1 supplied from the supply device 200 is wound by a rotation shaft 600a of the winding device 600 after traversing the conveyance unit 300, the printing unit 400, and the discharge guide unit 500.

The supply device 200 includes a rotation shaft 2 that supports the outer roll sheet R1 or the inner roll sheet R2, a sheet supply unit 60a for pulling the sheet 1 from the outer roll sheet R1 and supplying the sheet 1 to the conveyance unit 300, and a sheet supply unit 60b for pulling the sheet 1 from the inner roll sheet R2 and supplying the sheet 1 to the conveyance unit 300.

The sheet supply unit 60a includes a pivot member 7, which has two driven rollers, and an outer winding arm member 4, located below the outer roll sheet R1 in the vertical direction. The pivot member 7 and the arm member 4 are configured in an integrated manner, and are configured to be capable of rotating about a rotation shaft 5.

The sheet supply unit 60a includes a spring member 3. The spring member 3 is disposed so as to pressurize (bias) the arm member 4 and the pivot member 7 toward the center of the roll sheet R. Due to the bias of the outer winding arm spring member 3, the arm member 4 and the pivot member 7 contact the outer roll sheet R1 and pressurize the outer roll sheet R1. With the outer roll sheet R1 pressurized by the arm member 4 and the pivot member 7, the rotation shaft 2 is driven by a roll sheet driving unit (not shown) of the supply device 200, and the outer roll sheet R1 is rotated in a direction C1. This generates friction between the driven rollers of the pivot member 7 and the outer roll sheet R1, and the sheet 1 of the outer roll sheet R1 can be conveyed to a conveyance roller 14. The rotation shaft 2 is connected to a drive source of a roll drive motor (not shown), and can be driven forward or in reverse.

The sheet supply unit 60a includes a separation flapper 10. The separation flapper 10 is configured between the outer roll sheet R1 and the top of a supply port of the sheet supply unit 60a, and presses against the outer roll sheet R1 under its own weight. As a result, when the outer roll sheet R1 rotates, the leading end of the outer roll sheet R1 can be separated and the sheet 1 can be supplied to the supply port of the sheet supply unit 60a. The sheet supply unit 60a includes a sheet detection sensor 6 downstream from the supply port. The sheet detection sensor 6 detects the passage of the sheet 1. On the basis of the detection result from the sheet detection sensor 6, a control unit 700 of the printing apparatus 100 can identify that the roll sheet set in the supply device 200 is the outer roll sheet R1.

On the other hand, unlike the conveyance of the outer roll sheet R1, the sheet 1 cannot be pulled out from the inner roll sheet R2 to the conveyance roller 14 automatically and conveyed, and it is therefore necessary for the user to convey the leading end of the inner roll sheet R2 by hand.

The sheet supply unit 60b includes a supply guide 69 located above the inner roll sheet R2 set in the supply device 200 and a conveyance guide 61 located downstream from the supply guide 69 in the supply direction of the sheet 1. The user separates the leading end of the inner roll sheet R2 and places the sheet 1 onto the supply guide 69. The user then feeds the sheet 1 on the supply guide 69 in the conveyance direction along the conveyance guide 61, which brings the leading end of the inner roll sheet R2 to the conveyance roller 14. The sheet supply unit 60b includes a sheet detection sensor 67 in the conveyance guide 61. The sheet detection sensor 67 detects the passage of the sheet 1. On the basis of the detection result from the sheet detection sensor 67, the control unit 700 of the printing apparatus 100 can identify that the roll sheet set in the supply device 200 is the inner roll sheet R2.

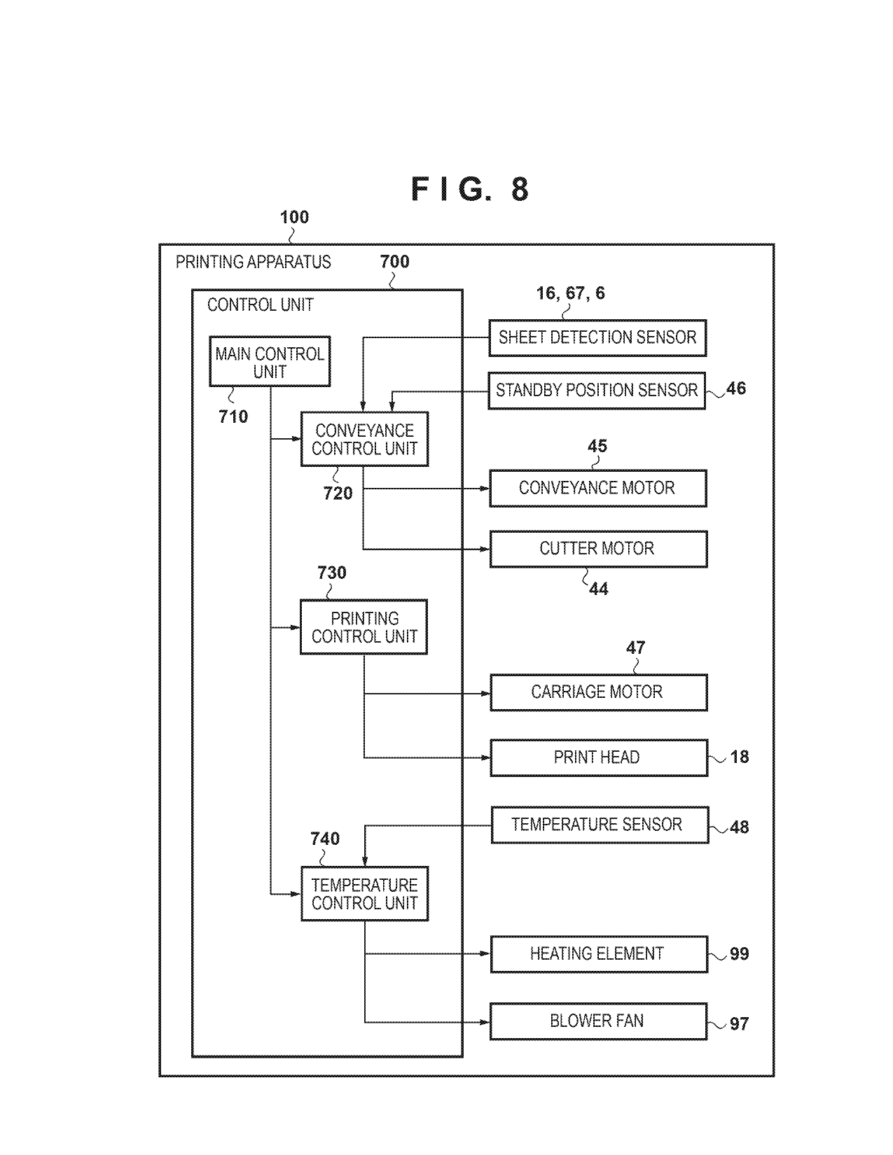

The conveyance unit 300 conveys the sheet 1 supplied by the supply device 200. The conveyance unit 300 includes a conveyance guide 12, the conveyance roller 14, a nip roller 15, and a sheet detection sensor 16. The conveyance guide 12 forms a conveyance path that guides the sheet 1 supplied from the supply device 200 to the printing unit 400. The conveyance roller 14 is driven forward and in reverse in the directions of arrows D1 and D2 by a conveyance motor 45 (see FIG. 8). The nip roller 15 can be rotationally driven by the rotation of the conveyance roller 14, and a nip roller separation motor (not shown) can bring the nip roller 15 closer to or away from the conveyance roller 14 and adjust a nip force thereof. The conveyance roller 14 is rotated on the basis of the sheet detection sensor 16 detecting the leading end of the sheet 1.

The printing unit 400 includes a print head 18. An image is printed on the sheet 1 by ejecting ink from the print head 18. The print head 18 uses an ejection energy generating element such as an electro-thermal conversion element (heater) or a piezoelectric element to eject ink serving as a printing agent from ejection ports. When an electro-thermal conversion element is used, bubbles can be formed in the ink by the heat generated by the element, and the ink can be ejected from the ejection ports using the energy of the bubbles. The print head 18 is not limited to the ink jet method only, nor is the printing method of the printing unit 400 limited, and a serial scanning method, a full-line method, or the like may be used instead, for example. When the serial scanning method is used, the image is printed during conveyance operations of the sheet 1 and scanning of the print head 18 in a direction intersecting with the conveyance direction of the sheet 1. When the full-line method is used, an image is printed using a long print head 18 that extends in a direction intersecting with the conveyance direction of the sheet 1, while continuously conveying the sheet 1. The sheet 1 on which the image has been printed by the printing unit 400 is conveyed to the downstream side of the printing unit 400 (the heating unit 90 and the discharge guide unit 500) by the conveyance unit 300.

The printing unit 400 also includes a platen 17 and a suction fan 19. The platen 17 is provided in a position opposite the print head 18, and has suction holes on a surface opposite the print head 18. The platen 17 suctions the surface of the sheet 1 on the side opposite to the printing surface of the sheet 1 through the suction holes using negative pressure produced by the suction fan 19. This makes it possible to regulate the position of the sheet 1 on the platen 17.

The heating unit 90 is disposed in a position opposite a guide surface S1 of the discharge guide unit 500, and heats the sheet 1 conveyed by the conveyance unit 300. In the present embodiment, the heating unit 90 blows hot air onto the sheet 1 guided by the discharge guide unit 500 to dry the ink ejected onto the sheet 1 by the printing unit 400. The ink can be fixed to the sheet 1 by using the heating unit 90 to dry the ink. The heating unit 90 includes support members 91 provided in four places on side wall parts 98b of a housing 98 of the heating unit 90 (described later). Each support member 91 contacts a spacer 81 provided in a base member 75 of the discharge guide unit 500 (described later), and supports the heating unit 90. A gap between a heating surface S2 (a hot air blowing surface) of the heating unit 90 and the guide surface S1 of the discharge guide unit 500 is defined as a result. The heating unit 90 is attached to the main body of the printing apparatus 100 by a linkage mechanism, and can be retracted to the top of the printing apparatus 100.

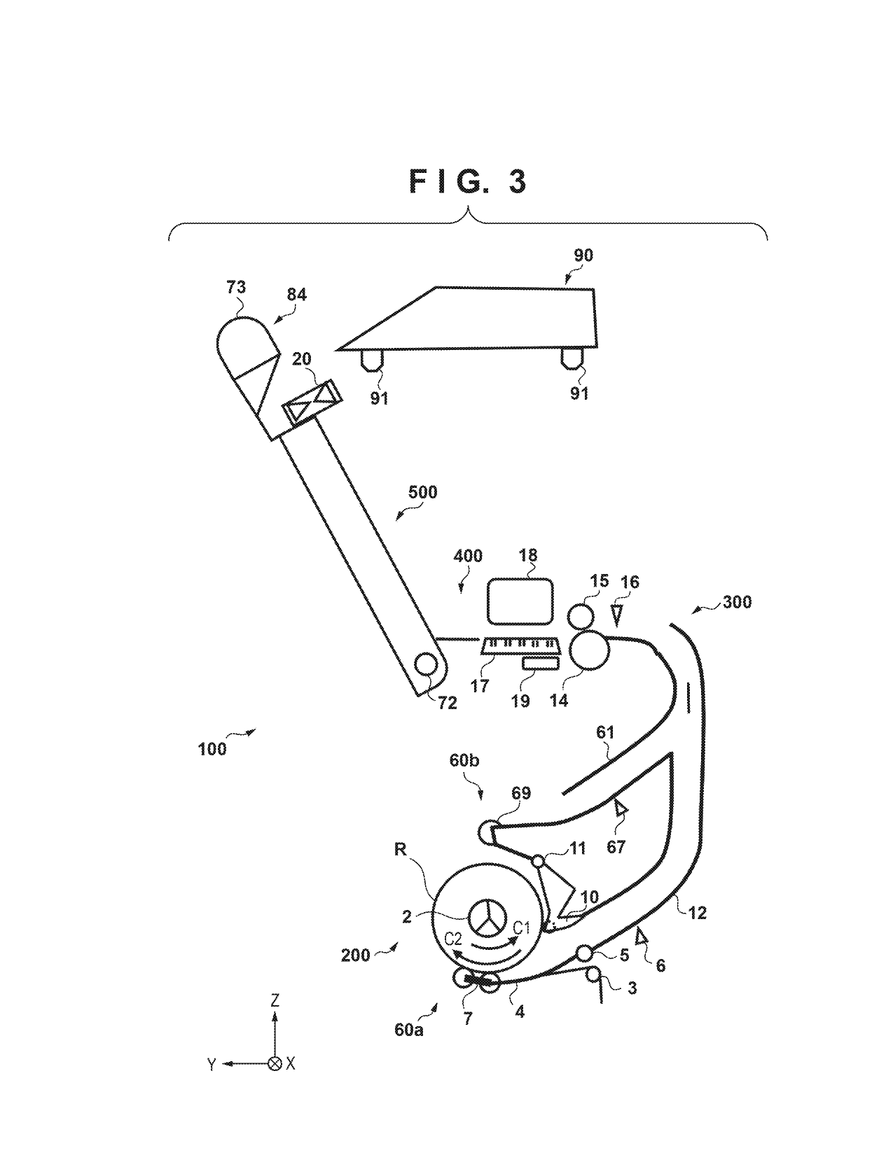

FIG. 3 is a cross-sectional view of the discharge guide unit 500 and the heating unit 90 when open. The discharge guide unit 500 is configured to be capable of being pivoted about a pivot shaft 72. Furthermore, as described above, the heating unit 90 is configured so as to be capable of being lifted and dropped by the linkage mechanism. The heating unit 90 is configured to be capable of retracting outside the pivot range of the discharge guide unit 500 (see FIG. 1B). Such a configuration makes it possible to attach and detach the roll sheet R without interfering with the discharge guide unit 500 by retracting the discharge guide unit 500 and the heating unit 90 upward when attaching and detaching the roll sheet R to and from the supply device 200. Although the present embodiment describes an example in which the discharge guide unit 500 pivots about the pivot shaft 72, the action is not limited to pivoting, and the discharge guide unit 500 may be configured to be lifted and dropped using a linkage mechanism or the like.

As described above, the heating unit 90 heats the sheet 1 with hot air to dry the ink on the sheet 1. For example, when the gap between the heating unit 90 and the guide surface S1 is small, the hot air flow will be stronger or weaker depending on the part of the sheet 1, and unevenness in the image formed on the sheet 1 can arise due to the air pattern. If the gap between the heating unit 90 and the guide surface S1 is large, the temperature of the sheet 1 may drop, and ink can remain unfixed as a result. In other words, the amount of heat on the sheet 1 may change depending on the distance (gap) between the heating unit 90 and the guide surface S1, which may affect the quality of the finished product (the sheet 1 after printing). Accordingly, the present embodiment will describe a configuration in which the sheet 1 can be heated uniformly.

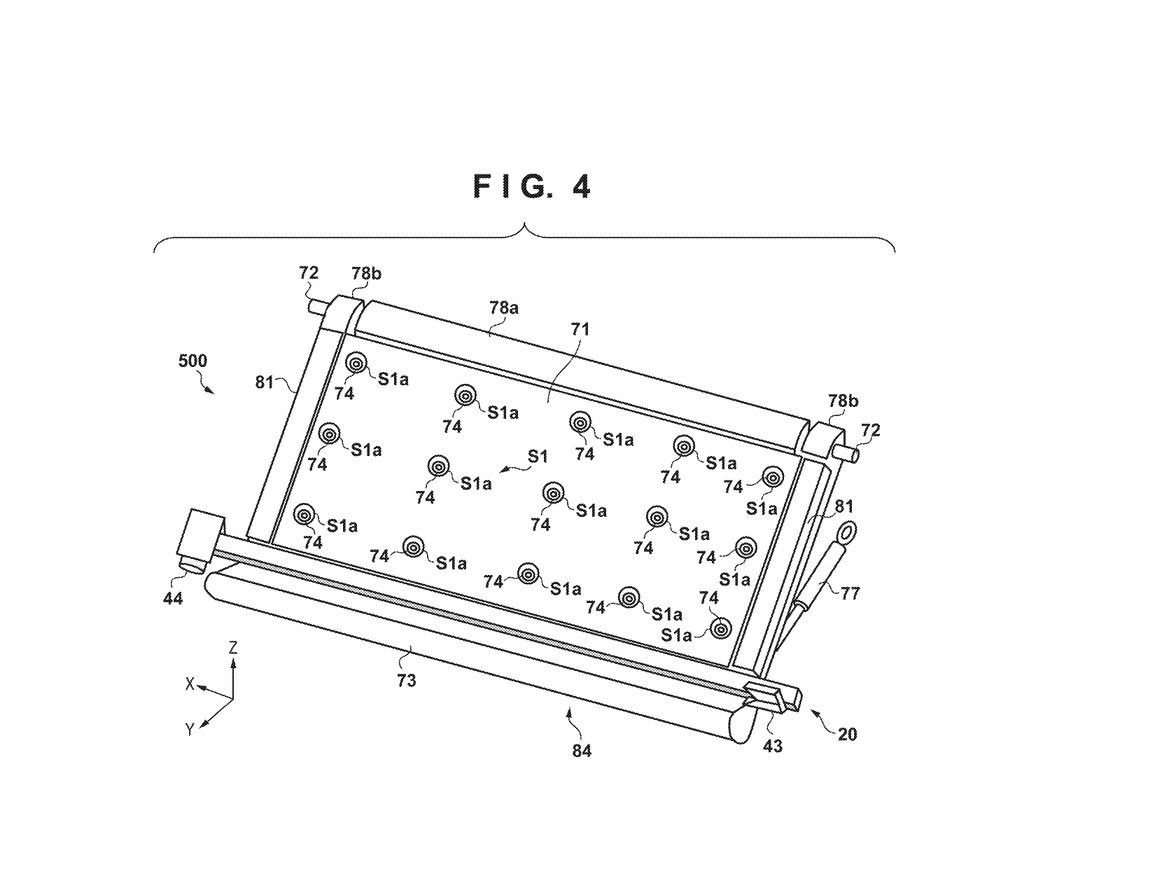

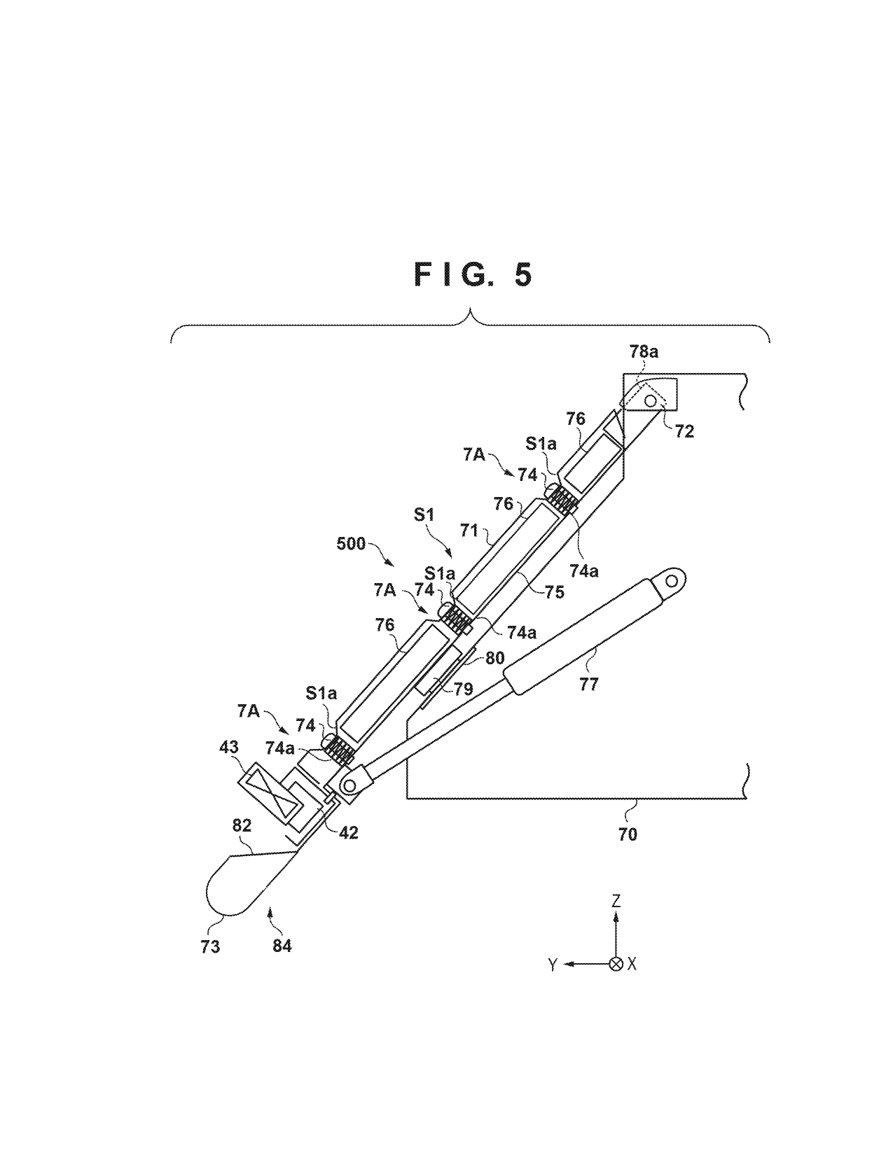

The configuration of the discharge guide unit 500 will be described with reference to FIGS. 4 and 5. FIG. 4 is a perspective view of the discharge guide unit 500, and FIG. 5 is a cross-sectional view of the discharge guide unit 500.

The discharge guide unit 500 includes a guide member 71 that forms the guide surface S1 that guides the rear surface of the sheet 1 conveyed by the conveyance unit 300, and the base member 75 for supporting the guide member 71 from the side opposite to the guide surface S1. The guide member 71 is heated directly by the hot air from the heating unit 90 or through the sheet 1, and also functions to promote the fixing and drying of the ink on the sheet 1 from the rear surface of the sheet 1. As such, the guide member 71 is constituted by a material having heat resistance and high thermal conductivity. For example, from the perspective of preventing heating unevenness and promoting the fixing and drying, a metal material such as a steel plate, SUS, an aluminum plate, or the like is used for the guide member 71. The present embodiment will describe an example in which a plate-shaped metal is used as the guide member 71.

The discharge guide unit 500 includes insulation 76 between the guide member 71 and the base member 75. Providing the insulation 76 between the guide member 71 and the base member 75 makes it difficult for heat to be transferred from the guide member 71 to the base member 75. Furthermore, the heat in the gap space between the heating unit 90 and the discharge guide unit 500 is less likely to cool, which makes it possible to reduce the amount of power used when heating the sheet 1 by the heating unit 90.

A cutting device 20 is attached to the base member 75 downstream from the guide member 71. The cutting device 20 cuts the sheet 1 by moving a cutter 43 in the X direction through the driving of a cutter motor 44. The cutter 43 moves in a groove between the guide member 71 and a guide member 84. The guide member 84, for guiding the sheet 1 to the winding device 600, is provided downstream from the cutting device 20. The guide member 84 is formed in an inclined shape in which an end 82 on the cutting device 20 side is inclined along the conveyance direction of the sheet 1. This enables the sheet 1 to be conveyed without the leading end of the sheet 1 catching on the guide member 84 after being cut by the cutter 43 in the groove between the guide member 71 and the guide member 84. An end 73 of the guide member 84 on the winding device 600 side is formed in a curved shape. The end 73 of the guide member 84 on the winding device 600 side being curved makes it possible to reduce damage such as folds and wrinkles in the sheet 1 when the sheet 1 is rolled by the winding device 600.

A guide member 78a and the guide member 78b guide the sheet 1 conveyed from the printing unit 400 to the discharge guide unit 500. The guide member 78a and the guide member 78b are located between the platen 17 and the guide member 71, and are formed in a curved shape because the sheet 1 makes contact therewith. The guide member 78a and the guide member 78b are disposed coaxially and have the same R dimension.

The printing apparatus 100 is provided with the spacer 81, which defines the gap between the base member 75 and the heating unit 90. Because the spacer 81 corresponds to a location where the support members 91 make contact, the spacer 81 is disposed further outside than the guide member 71 in a direction intersecting with the conveyance direction of the sheet 1. The spacer 81 is fixed to the base member 75.

The guide member 78a is provided in the main body of the printing apparatus 100, and is disposed so as not to interfere with the pivoting of the discharge guide unit 500. On the other hand, the guide member 78b is configured integrally with the discharge guide unit 500, and pivots with the discharge guide unit 500. According to this configuration, when the discharge guide unit 500 is open, a gap is formed between the guide member 71 and the guide member 78a, and the platen 17 can be seen from the front surface of the printing apparatus 100. Whether the leading end of the sheet 1 has reached the conveyance roller 14 can be confirmed because the inner roll sheet R2 is supplied by the roll sheet R being fed by hand.

The discharge guide unit 500 can pivot about the pivot shaft 72, and is pivoted when the roll sheet R is attached to and detached from the supply device 200. The pivot shaft 72 is attached to a side wall 70 of the main body of the printing apparatus 100, and a member having low sliding resistance such as a bearing is used for the pivot part.

A gas spring 77 is attached on the left and right of the lower side of the discharge guide unit 500, with one end fixed to the downstream rear side of the discharge guide unit 500 and the other end fixed to the side wall 70 of the main body of the printing apparatus 100. The gas spring 77 is capable of extending and retracting, and is biased in an extension direction. Accordingly, by attaching the gas spring 77 as illustrated in FIG. 5, the biasing force of the gas spring 77 makes it possible to open the discharge guide unit 500 with ease.

A reaction force setting of the gas spring 77 will be described next. It is necessary for the discharge guide unit 500 to be held open when the roll sheet R is set in the supply device 200, and the reaction force of the gas spring 77 is therefore set to a greater force than the force with which the discharge guide unit 500 closes under its own weight. However, if the reaction force holding the discharge guide unit 500 in the open state is prioritized, it may be difficult to hold the discharge guide unit 500 closed, and the discharge guide unit 500 may automatically open. A holding member 79 is therefore provided in the base member 75. A holding surface 80 on which the holding member 79 is held is configured on a side wall 70 of the printing apparatus 100 which is opposite the holding member 79 when the discharge guide unit 500 is closed. Here, the holding member 79 is a magnet and is held on the holding surface 80 of the side wall 70 by magnetism. Using a magnet having a holding force (magnetism) greater than the biasing force of the gas spring 77 makes it possible to hold the discharge guide unit 500 closed.

Note that depending on the weight of the discharge guide unit 500, the position of the center of gravity, and the arrangement of the gas spring 77, the discharge guide unit 500 can be held open by the gas spring 77, and can be held closed by the weight of the discharge guide unit 500 itself. In other words, the holding member 79 need not be provided in the base member 75.

Furthermore, although the present embodiment describes a configuration in which the printing apparatus 100 includes the gas spring 77, the configuration is not limited thereto. The printing apparatus 100 may be configured without the gas spring 77. The gas spring 77 may be provided as appropriate depending on the size of the printing apparatus 100, for example. For example, in a large-format printing apparatus 100, the discharge guide unit 500 is heavy, and thus the gas spring 77 may be provided. However, if the printing apparatus 100 is small, the discharge guide unit 500 is light, and thus the gas spring 77 may be omitted.

The discharge guide unit 500 includes an adjustment mechanism 7A that adjusts the distance between the guide surface S1 and the heating unit 90. In the present embodiment, the adjustment mechanism 7A adjusts the position of the guide member 71 with respect to an approaching-separation direction in which the guide member 71 approaches or separates from the heating unit 90. The sheet 1 can be heated uniformly by adjusting the distance between the guide surface S1 and the heating unit 90 using the adjustment mechanism 7A. This makes it possible to increase the quality of the finished product.

The adjustment mechanism 7A includes a support shaft 74 that supports the guide member 71 with respect to the base member 75 such that the position of the guide member 71 relative to the heating unit 90 in the approaching-separation direction can be varied. The support shaft 74 can also be said to be a member that adjusts the support height of the guide member 71 with respect to the base member 75. The support shaft 74 is a screw. Note that the support shaft 74 may be a screw, a bolt, or the like. The support shaft 74 is inserted through the guide member 71 and fixed to the base member 75.

The adjustment mechanism 7A includes an elastic member 74a provided between the guide member 71 and the base member 75. The elastic member 74a is a compression spring. The support shaft 74 is inserted through the center of the elastic member 74a and fixed to the base member 75. The elastic member 74a biases the guide member 71 to the leading end portion (upper end) of the support shaft 74 with respect to the base member 75. As a result, when the support shaft 74 is tightened, the guide member 71 moves toward the base member 75. On the other hand, when the support shaft 74 is loosened, the guide member 71 can be moved away from the base member 75.

In addition, even if the guide member 71 expands thermally when the sheet 1 is heated by the heating unit 90, due to the elastic member 74a, the guide member 71 only contacts the head surface of the support shaft 74 in the Z direction, and is not completely fixed in the X and Y directions. This makes it possible to compensate for the expansion.

A plurality of support shafts 74 are provided in the guide member 71, and the position of the guide member 71 relative to the heating unit 90 in the approaching-separation direction can be adjusted for each of the support shafts 74. This makes it possible to adjust the distance to the heating unit 90 at each area of the guide member 71, even when the size of the guide member 71 is relatively large.

The guide surface S1 includes a plurality of recesses S1a. The leading end portion of each of the plurality of support shafts 74 is contained within a corresponding one of the recesses S1a. This prevents the leading end portion of the support shaft 74 from lifting the sheet 1 when the sheet 1 is heated by the heating unit 90, which in turn makes it possible to heat the sheet 1 uniformly. Furthermore, the leading end portion of the support shaft 74 does not protrude when the sheet 1 is conveyed, which makes it possible to prevent situations where the conveyance of the sheet 1 is obstructed.

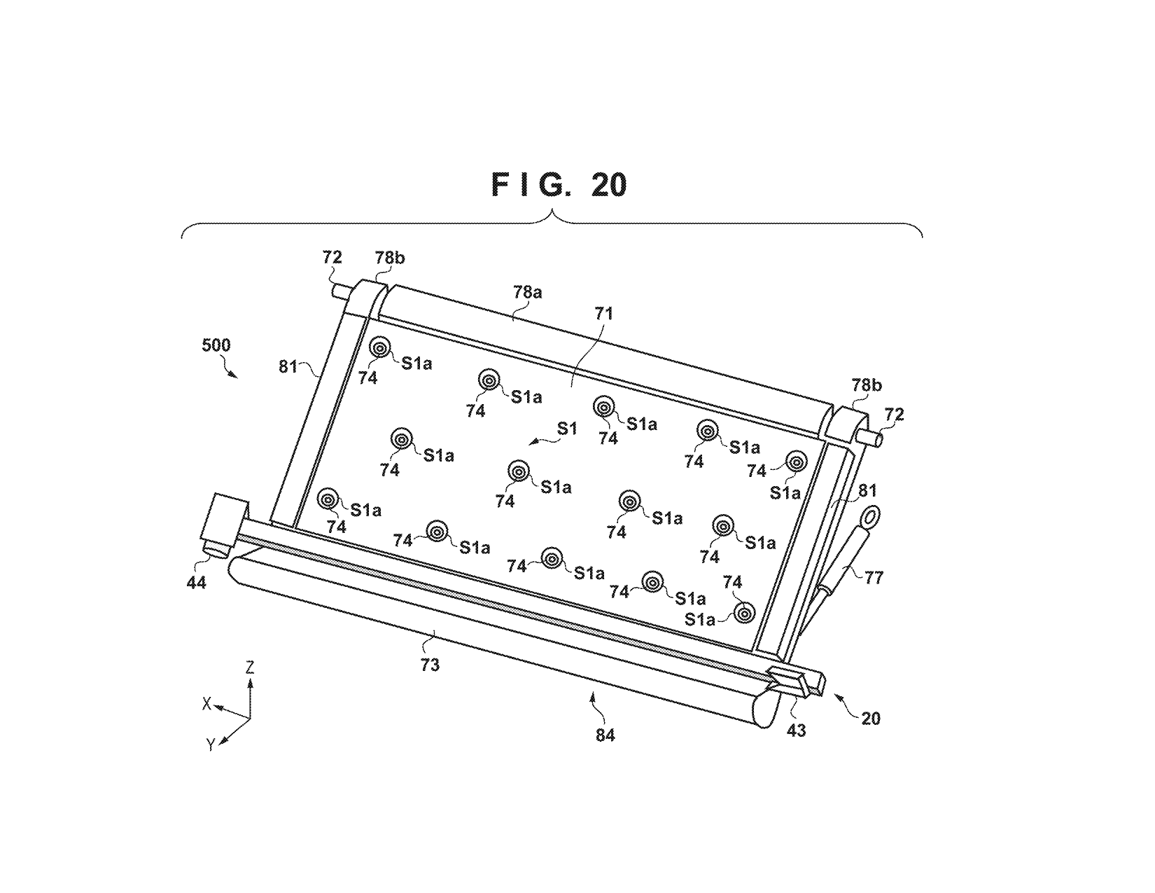

In the present embodiment, the plurality of recesses S1a are formed in matrix form in the guide surface S1 along the conveyance direction of the sheet 1 conveyed by the conveyance unit 300, as illustrated in FIG. 4. However, the configuration is not limited thereto. See FIG. 20. FIG. 20 is a perspective view of the discharge guide unit 500, illustrating another example of the recesses. The plurality of recesses S1a may be formed in a staggered pattern in the guide surface S1 along the conveyance direction of the sheet 1 conveyed by the conveyance unit 300. The sheet 1 does not come into contact with the guide member 71 in the areas where the recesses S1a are present, and thus the temperature of the sheet 1 may vary compared to the areas of contact. Forming the plurality of recesses S1a in a staggered pattern makes it possible to suppress local imbalances in temperature variation, and heat the sheet 1 more uniformly, compared to when the plurality of recesses S1a are formed in a matrix.

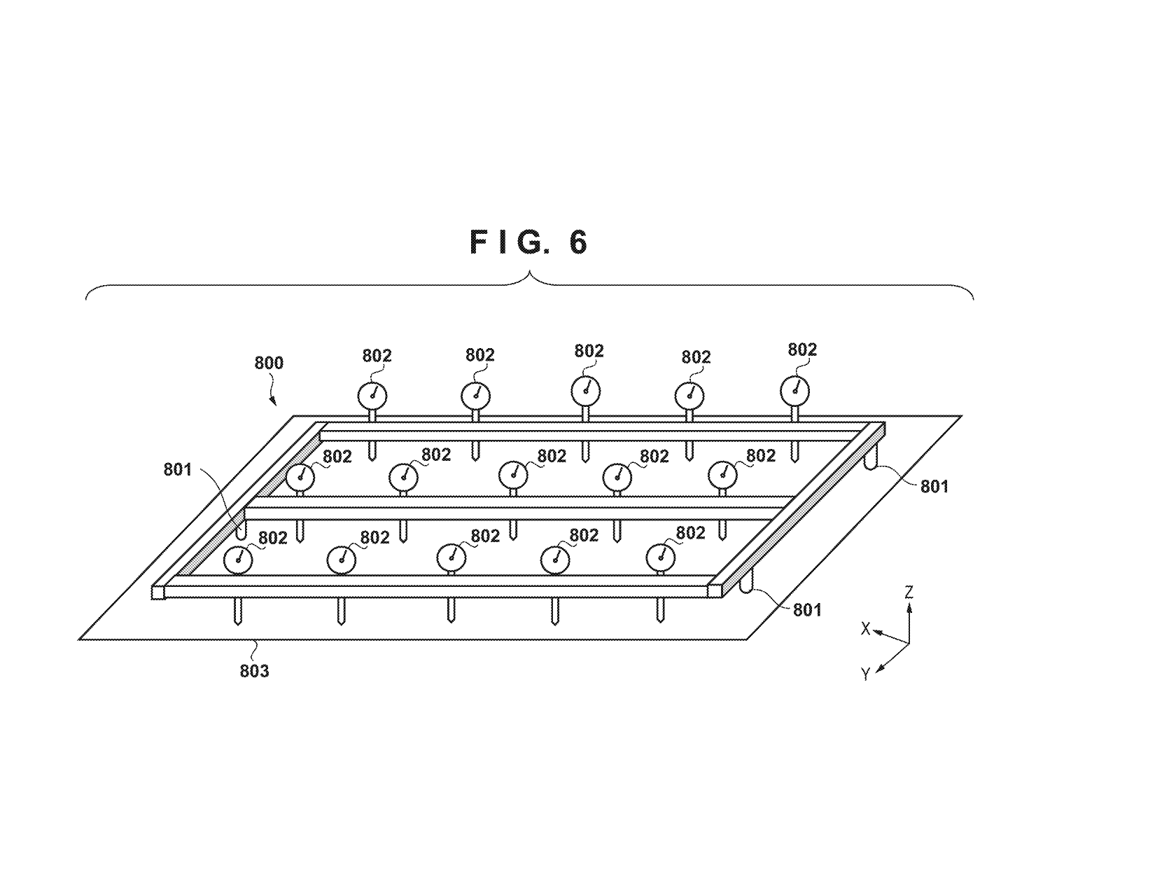

FIG. 6 is a perspective view of an adjustment tool 800 for adjusting the flatness of a target object. The adjustment tool 800 is constituted by a plurality of stays, and includes support members 801 and dial gauges 802. The support member 801 is disposed in three positions that can come into contact with the spacer 81. The dial gauges 802 are measurement devices for measuring the flatness of an object to be adjusted. The dial gauges 802 are provided in positions where the flatness of the guide member 71 is to be adjusted. In other words, the dial gauges 802 are disposed in positions where the guide surface S1 around the support shaft 74 that secures the guide member 71 and the base member 75 can be measured.

The adjustment tool 800 performs pre-adjustment on a surface plate 803. With the surface plate 803 in contact at the three points corresponding to the support members 801, a memory is set such that the measurement values of the dial gauges 802 are zero. Then, with the discharge guide unit 500 closed, the pre-adjusted adjustment tool 800 is placed on the discharge guide unit 500, and the flatness of the guide member 71 is adjusted using the adjustment mechanism 7A on the basis of the measurement values on the dial gauges 802.

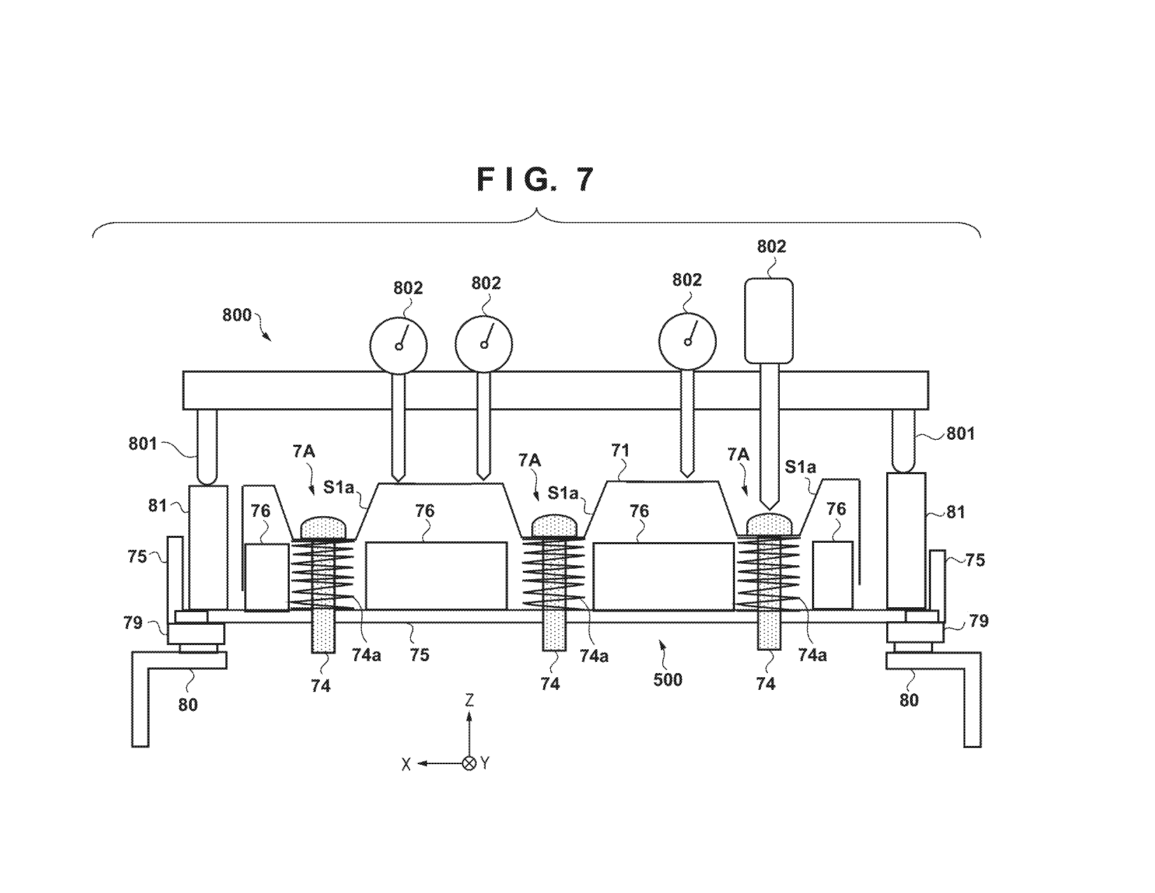

FIG. 7 is a cross-sectional view seen in the Y direction, when the adjustment tool 800 is placed on the closed discharge guide unit 500. As described above, when the discharge guide unit 500 is closed, two points corresponding to the holding members 79 are in contact with the holding surface 80. In addition, the position of the adjustment tool 800 relative to the spacer 81 is determined by a supprt member 801 making contact at three locations. In this state, the height of the guide member 71 and the flatness of the guide member 71 can be adjusted by tightening or loosening the support shaft 74 while viewing the numerical values on the dial gauges 802. In the present embodiment, the value is set to zero while on the surface plate 803 through the pre-adjustment. Therefore, for example, if a flatness of 0.2 is required, the height of the guide member 71 may be adjusted in the range where the measurement values for all the dial gauges 802 are between +0.1 and −0.1.

FIG. 8 is a block diagram illustrating an example of the configuration of a control system of the printing apparatus 100. The printing apparatus 100 includes the control unit 700. The control unit 700 includes a main control unit 710, a conveyance control unit 720, a printing control unit 730, a temperature control unit 740, and the like. The main control unit 710 includes a CPU, a ROM, a RAM, a motor driver, and the like (not shown), and controls the printing apparatus 100 as a whole. In addition, the main control unit 710 provides various commands to the conveyance control unit 720, the printing control unit 730, and the temperature control unit 740, and controls the various parts of the apparatus.

The conveyance control unit 720 detects the position of the sheet 1 using the sheet detection sensor 16, the sheet detection sensor 67, the sheet detection sensor 6, and the like. The conveyance control unit 720 drives the conveyance motor 45 while identifying the position of the sheet 1 on the basis of the detection result from each sheet detection sensor, and conveys the sheet 1 to the desired position using the conveyance roller 14. In addition, the conveyance control unit 720 detects the position of the cutter 43 using a standby position sensor 46, drives the cutter motor 44, and cuts the sheet 1 using the cutting device 20.

The printing control unit 730 controls the printing unit 400. The printing control unit 730 controls the print head 18 to print an image on the sheet 1 while driving a carriage motor 47 to move the print head 18 back and forth in a direction intersecting with the conveyance direction of the sheet 1.

The temperature control unit 740 controls the heating unit 90 according to a control program stored in the ROM. The temperature control unit 740 detects a temperature using a temperature sensor 48, and adjusts the strength of a blower fan 97 and the temperature of a heating element 99 provided inside the heating unit 90.

### Second Embodiment

The first embodiment described a configuration in which the support shaft 74 is inserted through the guide member 71 and fixed to the base member 75. However, if the support shaft 74 is made of metal, heat from the guide member 71 heated by the heating unit 90 transfers to the base member 75 easily through the support shaft 74, making it easy for heat to escape from the base member 75. Accordingly, the present embodiment will describe a configuration for efficiently utilizing the heat from the heating unit 90.

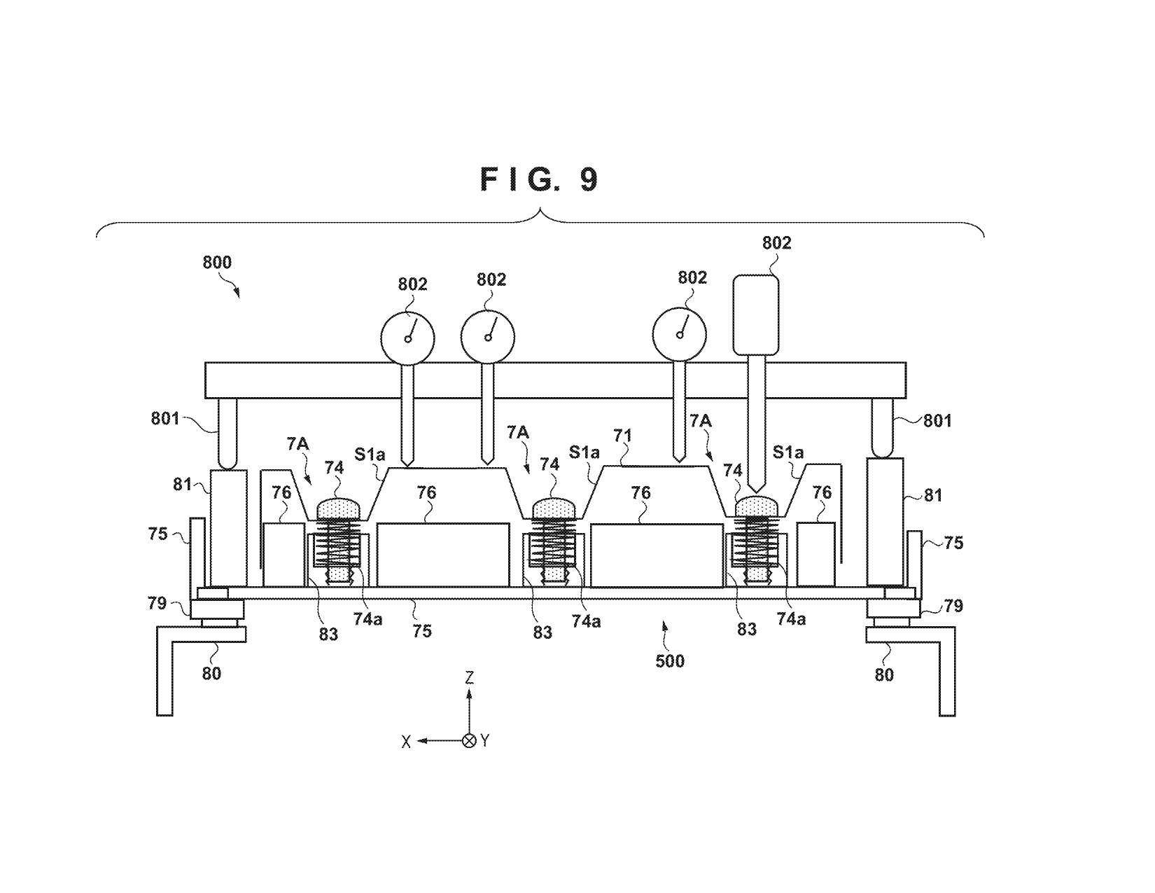

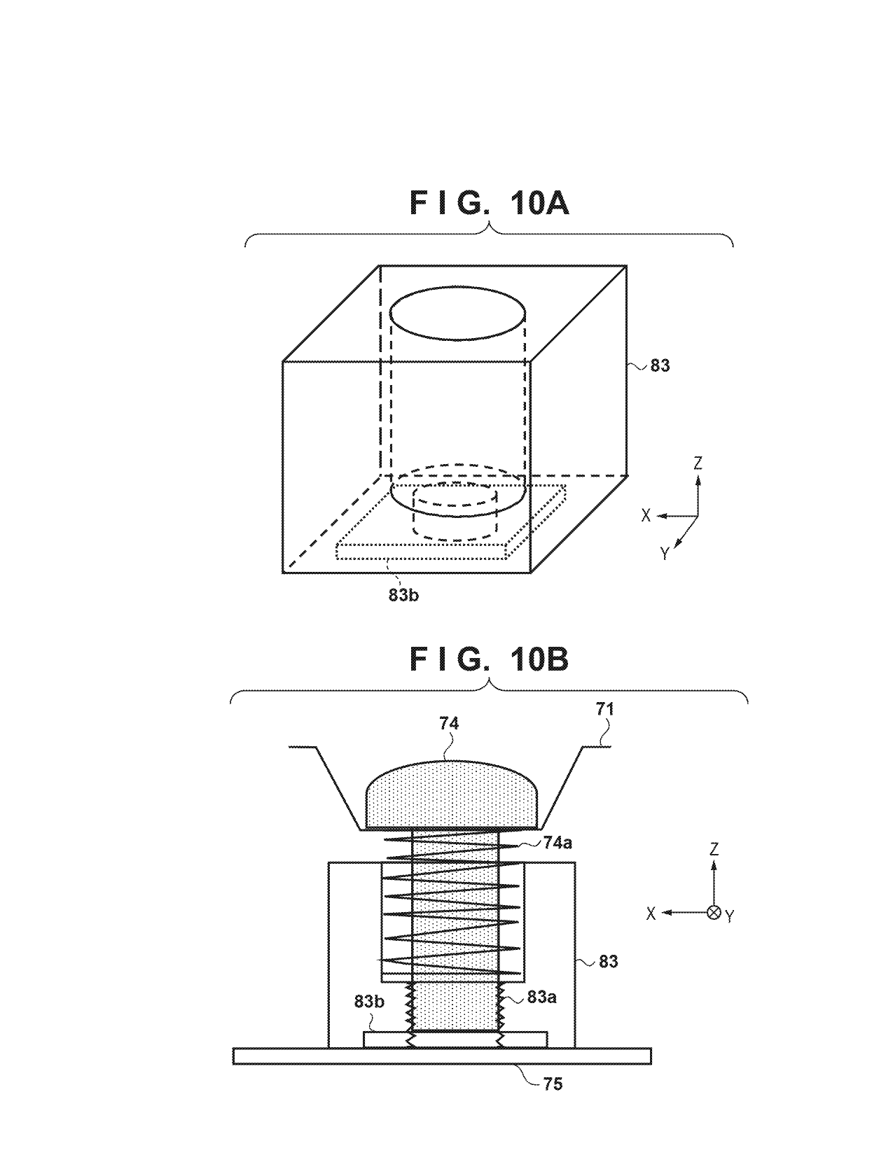

FIG. 9 is a cross-sectional view, seen in the Y direction, when an insulating member 83 made from a heat-resistant resin is attached between the guide member 71 and the base member 75. FIGS. 10A and 10B are detailed diagrams illustrating the configuration of the insulating member 83.

In the present embodiment, the discharge guide unit 500 has the insulating member 83 between the support shaft 74 and the base member 75. As illustrated in FIGS. 10A and 10B, a cylindrical hole in which the elastic member 74a is disposed is formed in the insulating member 83, and a fixing portion 83a for fixing the support shaft 74 is provided in a lower part of the hole. A threading groove is formed in the fixing portion 83a, and the fixing portion 83a can therefore be threaded with threads provided in the lower end of the support shaft 74. This enables the support shaft 74 to be fixed to the insulating member 83. The diameter of the cylindrical hole is larger than the outer shape of the elastic member 74a. This makes it possible to suppress a large shift in the elastic member 74a during assembly. The insulating member 83 is fixed to the base member 75 by a screw or the like over a fixing portion 83b. The height of the insulating member 83 ensures a gap is formed between the recesses S1a of the guide member 71 and the insulating member 83 such that the adjustment of the flatness of the guide member 71 is not interfered with. Here, the fixing portion 83a may be configured as a nut embedded in the insulating member 83.

In this manner, in the present embodiment, the insulating member 83 made from a resin is disposed between the guide member 71 and the base member 75. The thermal conductivity of the resin is lower than that of metal, which suppresses heat transfer from the guide member 71 to the base member 75. The heat from the heating unit 90 can therefore be used efficiently.

### Third Embodiment

The first and second embodiments described the adjustment mechanism 7A that adjusts the position of the guide member 71 relative to the heating unit 90 in the approaching-separation direction as a mechanism that adjusts the distance between the heating unit 90 and the guide surface S1. The present embodiment will describe an adjustment mechanism that adjusts the distance of the heating unit 90 from the guide member 71 in the approaching-separation direction as the mechanism that adjusts the distance between the heating unit 90 and the guide surface S1. Note that the printing apparatus 100 according to the present embodiment may have the adjustment mechanism 7A in the same manner as in the foregoing embodiments.

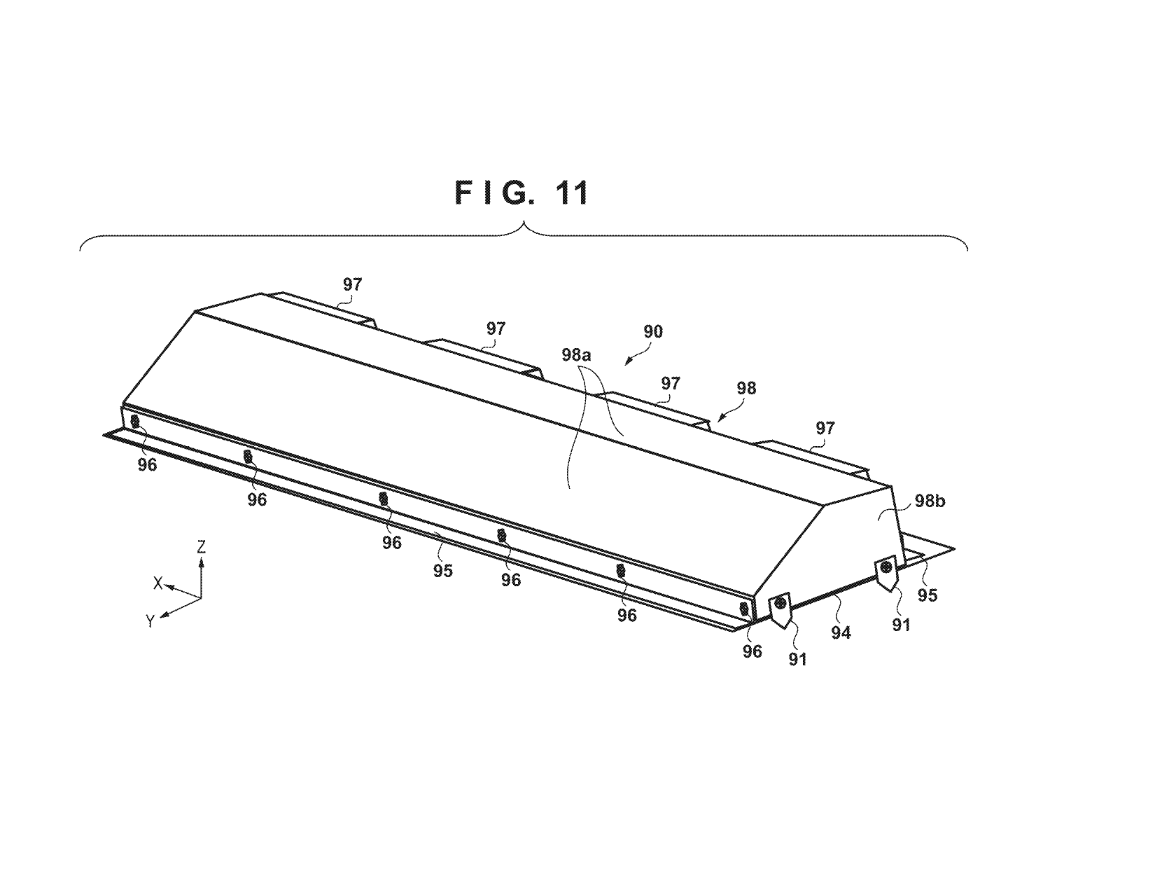

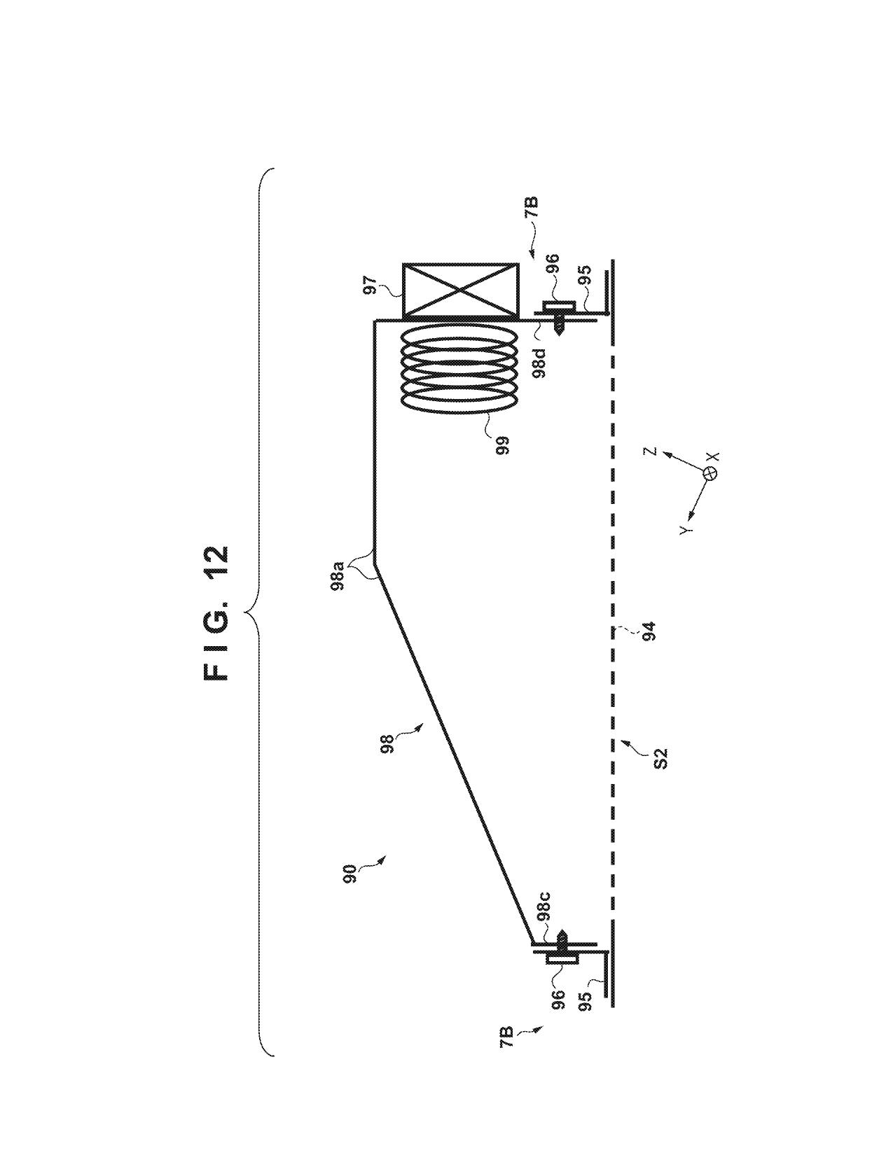

The configuration of the heating unit 90 in the present embodiment will be described next with reference to FIGS. 11 and 12. FIG. 11 is a perspective view of the heating unit 90. FIG. 12 is a cross-sectional view of the heating unit 90 seen in the X direction.

The heating unit 90 includes the heating element 99, as well as a heating plate 94 which has a plurality of exhaust holes S2a that discharge gas heated by the heating element 99 and which forms the heating surface S2 opposite the guide surface S1. The heating element 99 is a heater, and various types of heaters, such as a resistive heater or an induction heater can be used.

The heating unit 90 also includes the housing 98, which forms a space that accommodates the gas heated by the heating element 99 and supports the heating plate 94, and the blower fan 97 for discharging the hot air from the heating plate 94. The housing 98 is constituted by an upper wall part 98a, a side wall part 98b, a front wall part 98c, and a rear wall part 98d. The upper wall part 98a is disposed in a position opposite the heating plate 94, and forms an upper surface of the housing 98. The side wall part 98b is disposed in a direction intersecting with the conveyance direction of the sheet 1, and forms a side surface of the housing 98. The front wall part 98c is disposed upstream in the conveyance direction of the sheet 1, and forms a front surface of the housing 98. The rear wall part 98d is disposed downstream in the conveyance direction of the sheet 1, and forms a rear surface of the housing 98.

As described above, the support member 91 is provided in the side wall part 98b of the housing 98. At least three support members 91 are provided, each of which contacts the spacer 81 and supports the heating unit 90, defining a gap between the base member 75 and the heating unit 90 as a result. The configuration of the heating unit 90 described thus far is the same as in the first and second embodiments.

In the present embodiment, the printing apparatus 100 includes an adjustment mechanism 7B that adjusts the distance between the guide surface S1 and the heating unit 90. The adjustment mechanism 7B adjusts the position of the heating plate 94 relative to the guide surface S1 in the approaching-separation direction. In this manner, the sheet 1 can also be heated uniformly by adjusting the position of the heating plate 94 relative to the guide surface S1 in the approaching-separation direction.

The adjustment mechanism 7B includes a fixing member 96 that fixes the heating plate 94 and the housing 98 such that the heating plate 94 can displace relative to the guide surface S1 in the approaching-separation direction. The adjustment mechanism 7B includes an adjustment plate 95 for displacing the heating plate 94 in the approaching-separation direction. The adjustment plate 95 is fixed to the heating plate 94 on both the upstream and downstream sides in the conveyance direction of the sheet 1 by welding or the like. The adjustment plate 95 is fixed to the housing 98 by the fixing member 96.

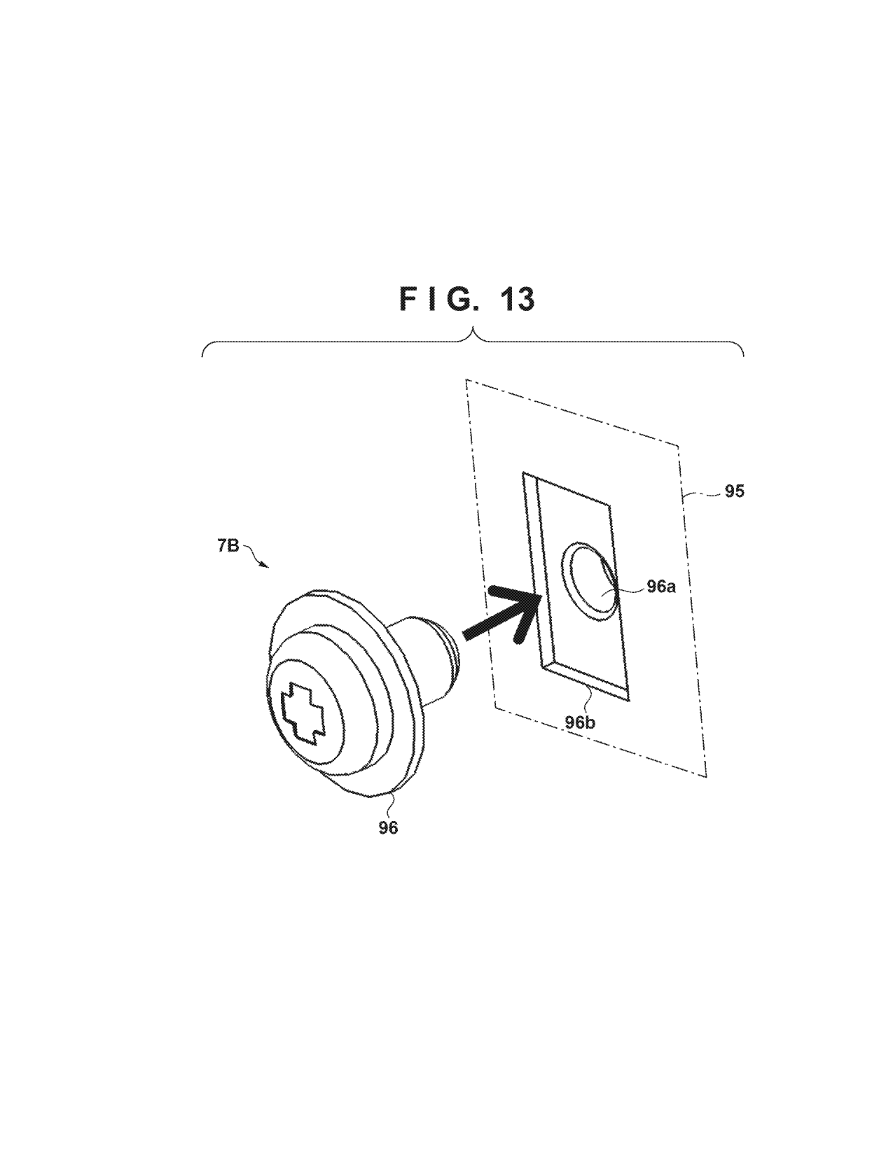

FIG. 13 is a diagram illustrating the adjustment mechanism 7B in detail. The fixing member 96 is a screw, a screw, a bolt, or the like. The adjustment plate 95 is provided with a plurality of long holes 96b extending in the vertical direction of the housing 98. After the adjustment plate 95 is moved to a desired position in the vertical direction of the housing 98, the fixing member 96 is fastened to a screw fastening hole 96a over the adjustment plate 95. This enables the heating plate 94 to displace relative to the guide surface S1 in the approaching-separation direction.

A plurality of the fixing members 96 are provided in the housing 98, and the heating plate 94 can displace relative to the guide surface S1 in the approaching-separation direction at each fixing member 96. As a result, in a large-format printing apparatus 100 capable of conveying a sheet 1 that is wider than 60 inches, for example, the heating plate 94 may be large, but the distance from the guide surface S1 can be adjusted at each location of the heating plate 94.

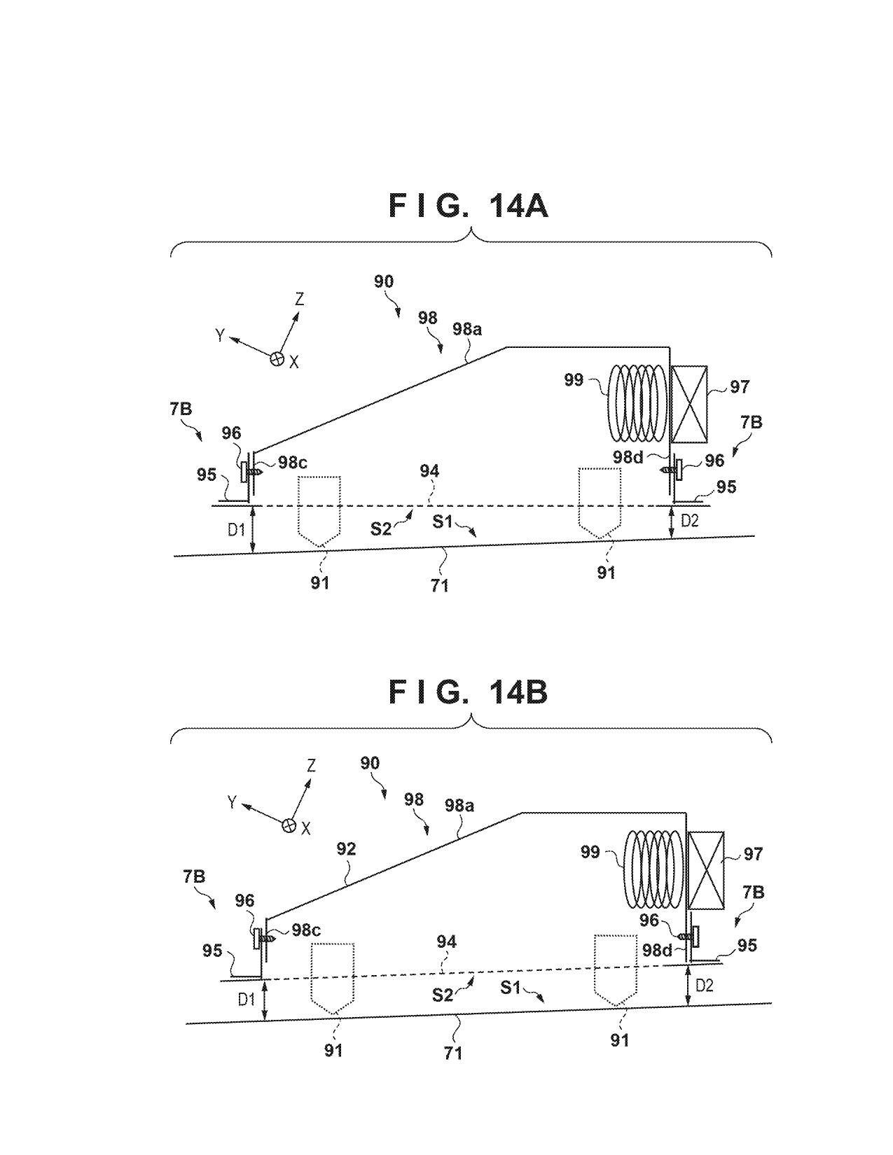

FIGS. 14A and 14B are diagrams illustrating an example of the adjustment of the heating plate 94 using the adjustment mechanism 7B according to the present embodiment. FIG. 14A is a cross-sectional view of the periphery of the heating unit 90 before adjustment using the adjustment mechanism 7B. The gap between the guide surface S1 of the discharge guide unit 500 and the heating plate 94 is small on the upstream side, and large on the downstream side, in the conveyance direction of the sheet 1. FIG. 14B is a cross-sectional view of the periphery of the heating unit 90 after adjustment using the adjustment mechanism 7B. The adjustment plates 95 on the upstream and downstream sides in the conveyance direction of the sheet 1 are fixed to the housing 98 by the fixing members 96 after the adjustment plates 95 are moved in the vertical direction. As illustrated in FIG. 14B, using the adjustment mechanism 7B to adjust the position of the heating plate 94 relative to the guide surface S1 in the approaching-separation direction makes it possible to ensure that the gap or distance between the heating unit 90 and the guide surface S1 is uniform throughout the conveyance direction.

### Fourth Embodiment

The third embodiment described an example in which the heating plate 94 is fixed to the housing 98 by the fixing member 96 over the adjustment plate 95. The present embodiment will describe areas that are different from the third embodiment.

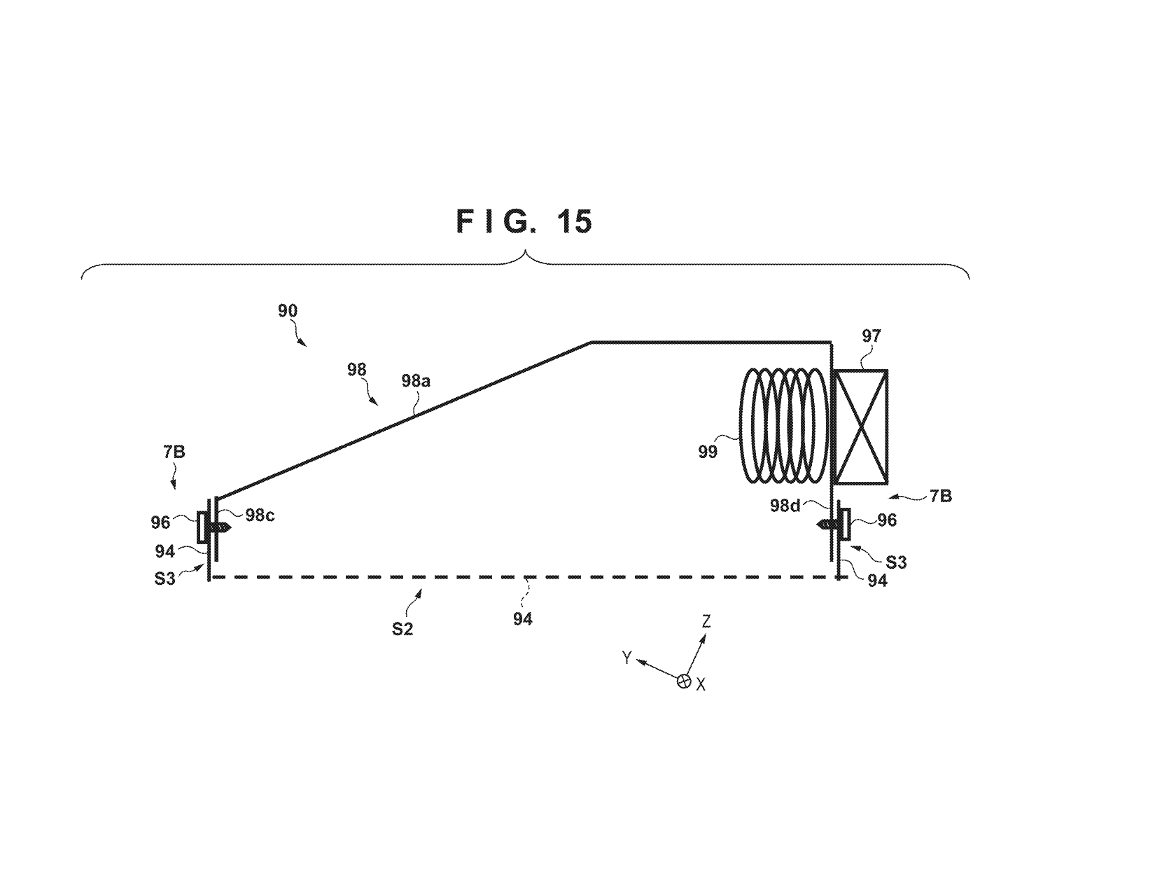

FIG. 15 is a cross-sectional view of the heating unit 90 according to the present embodiment. The heating plate 94 has a surface S3 extending in the vertical direction relative to the heating surface S2 by being bent or the like on the upstream and downstream sides in the conveyance direction of the sheet 1. Like the adjustment plate 95 according to the third embodiment, the surface S3 is provided with a plurality of long holes (not shown) extending in the vertical direction. In this manner, the configuration may be such that the heating plate 94 and the housing 98 are directly fixed by the fixing member 96 without using the adjustment plate 95.

### Fifth Embodiment

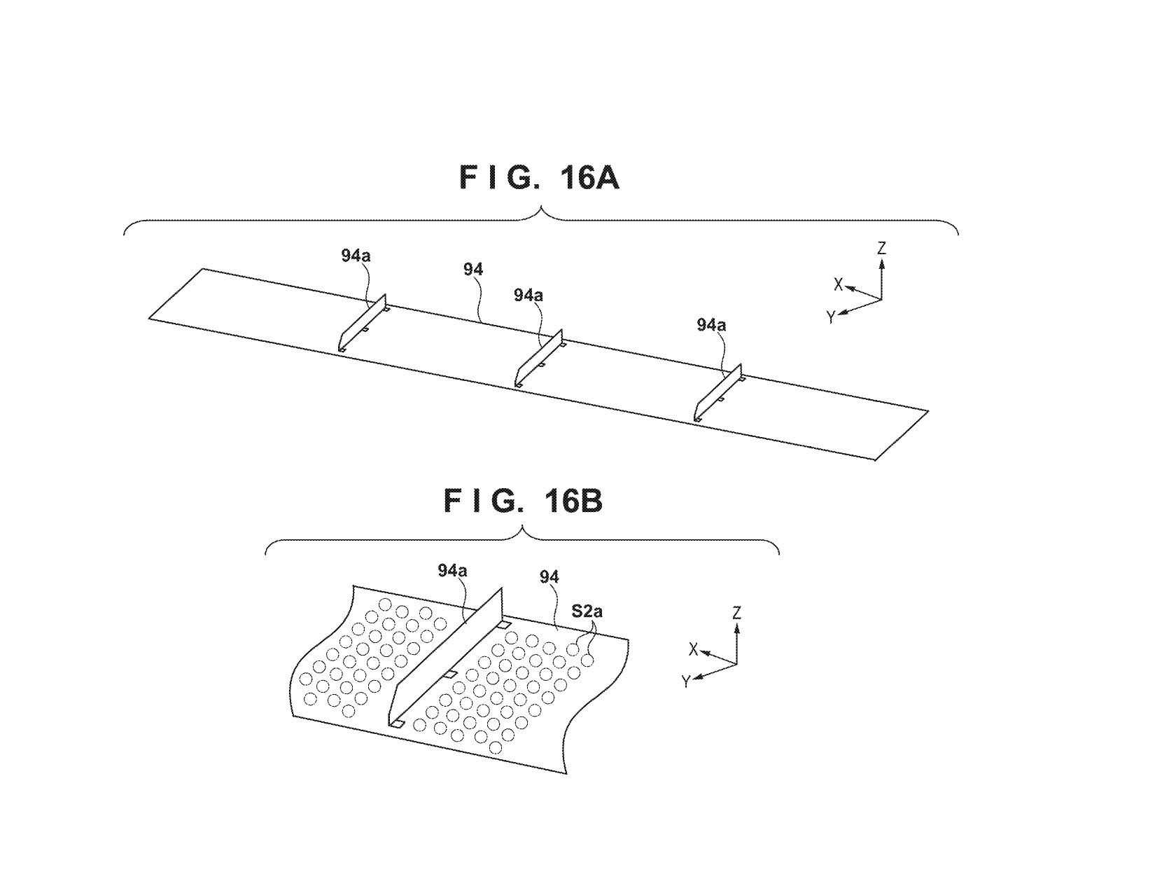

Another example of the configuration of the heating plate 94 will be described next. FIG. 16A is a perspective view illustrating the heating plate 94 according to the present embodiment. FIG. 16B is an enlarged view of a part of the heating plate 94 illustrated in FIG. 16A.

As illustrated in FIG. 16A, the heating plate 94 is shaped such that the length thereof in a direction intersecting the conveyance direction in which the sheet 1 is conveyed by the conveyance unit 300 is shorter than the length in the conveyance direction of the sheet 1. The printing apparatus 100 includes a reinforcement member 94a extending in the short-side direction of the heating plate 94. The reinforcement member 94a is provided on a surface opposite to the side on which the heating surface S2 of the heating plate 94 is located. At least one reinforcement member 94a is disposed in the long-side direction of the heating plate 94, and each reinforcement member 94a is fixed to the heating plate 94 in at least three locations by welding or the like. Providing the reinforcement member 94a on the heating plate 94 makes it possible to prevent deformation and bending in the heating plate 94, which in turn makes it possible to heat the sheet 1 more uniformly.

### Sixth Embodiment

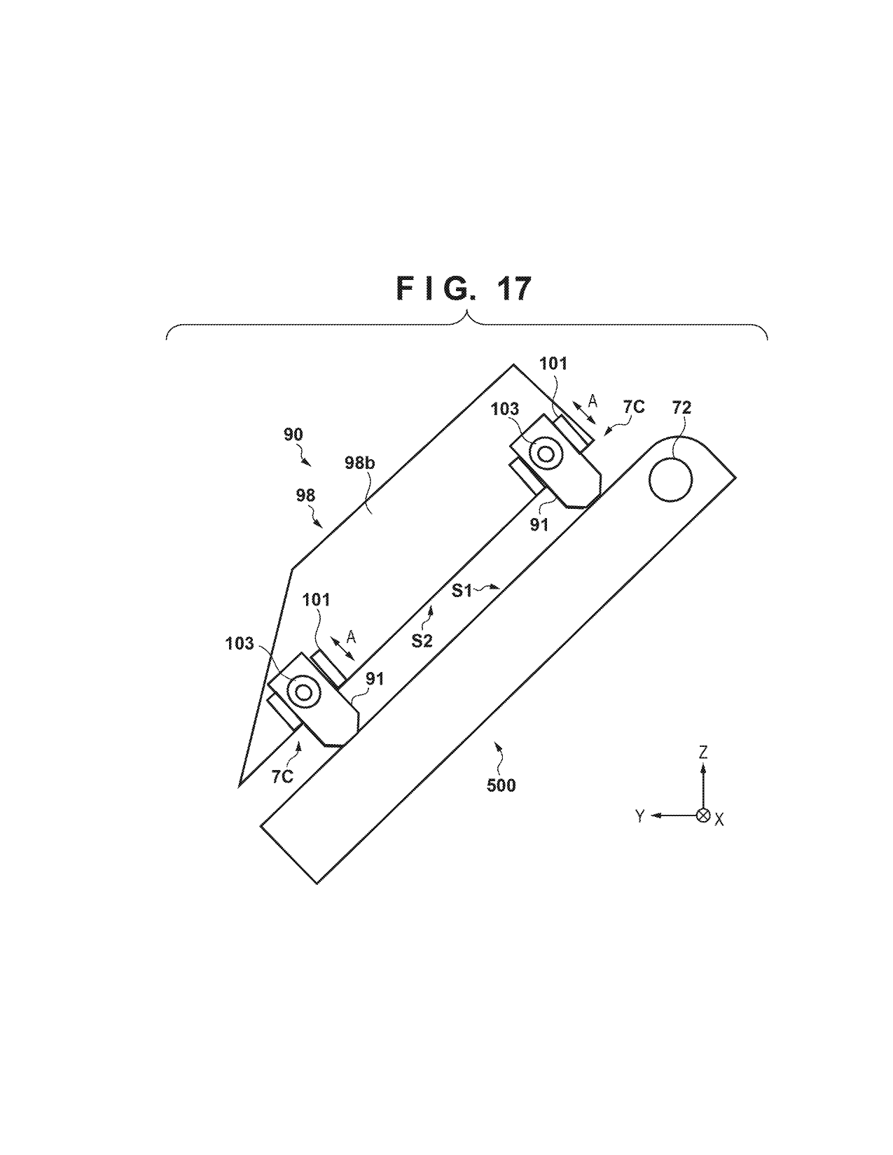

The third embodiment described the adjustment mechanism 7B that adjusts the distance of the heating unit 90 relative to the guide member 71 in the approaching-separation direction as the mechanism that adjusts the distance between the heating unit 90 and the guide surface S1. The present embodiment will describe another example of the adjustment mechanism with reference to FIGS. 17 to 19.

FIG. 17 is a side view of the discharge guide unit 500 and the heating unit 90. The heating unit 90 is supported on the discharge guide unit 500 by the support member 91 provided on the side wall part 98b of the housing 98.

In the present embodiment, the printing apparatus 100 includes an adjustment mechanism 7C that adjusts the distance between the guide surface S1 and the heating unit 90. The adjustment mechanism 7C adjusts the position of the heating plate 94 relative to the guide surface S1 in the approaching-separation direction. In the present embodiment, the adjustment mechanism 7C includes the support member 91, as well as a fixing member 103 that fixes the support member 91 and the housing 98 such that the heating plate 94 can displace in the relative to the guide surface S1 in the approaching-separation direction.

Using the fixing member 103 to adjust the fixing position of the support member 91 and the housing 98 makes it possible for the position of the heating plate 94 relative to the guide surface S1 in the approaching-separation direction to displace.

The adjustment mechanism 7C includes a guide member 101, provided in the housing 98, that guides the support member 91 and the fixing member 103 in a vertical direction A of the housing 98. When adjusting the stated fixing position, the support member 91 and the fixing member 103 are guided in the vertical direction A of the housing 98 by the guide member 101. The guide member 101 is disposed in two places approximately equal to the width of the support member 91, and as a result, the support member 91 can be adjusted in the vertical direction A of the housing 98 by moving along the guide member 71.

Although the adjustment mechanism 7C illustrated in FIG. 17 has been described as including the guide member 71, the configuration is not limited thereto.

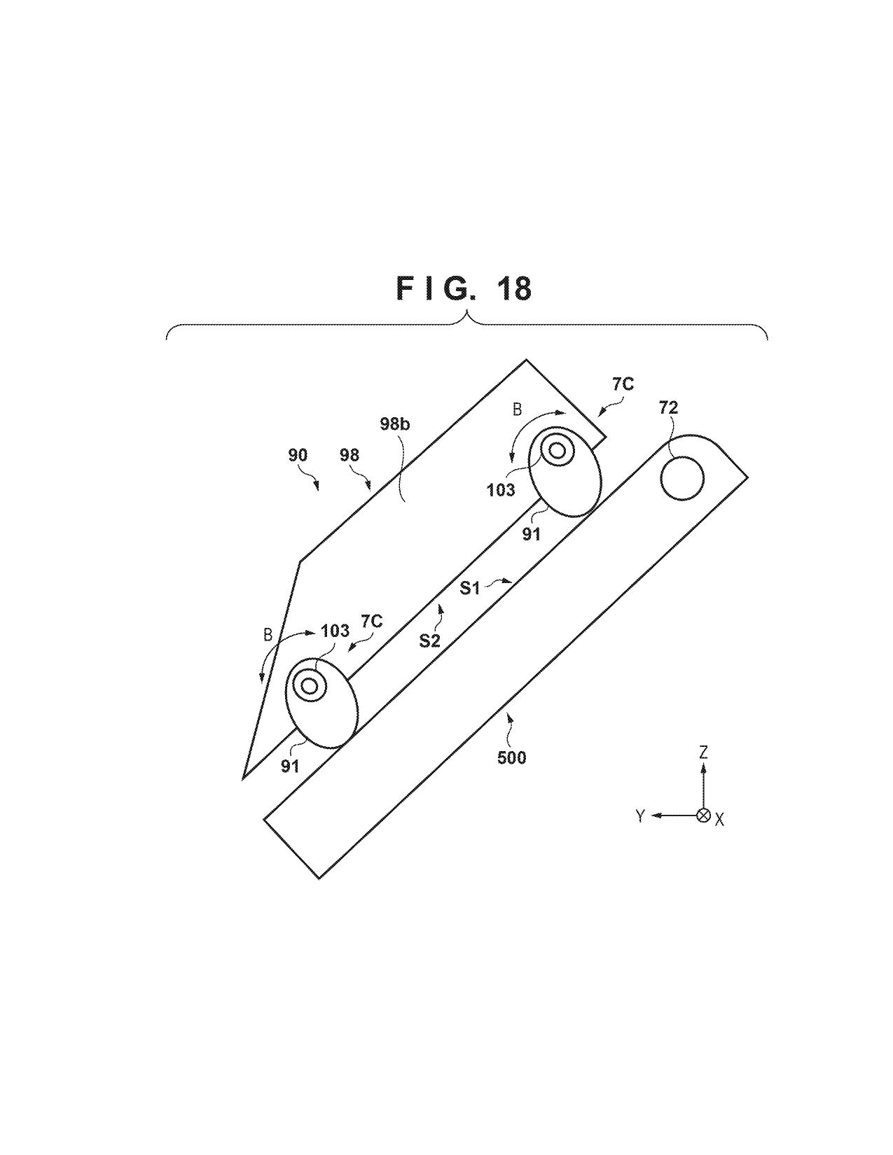

FIG. 18 illustrates another example of the adjustment mechanism 7C. In the adjustment mechanism 7C in FIG. 18, the support member 91 is a cam capable of pivoting. The cam as the support member 91 can pivot in the direction of an arrow B when the fixing by the fixing member 103 is released. The amount by which the heating plate 94 displaces relative to the guide surface S1 in the approaching-separation direction is adjusted according to the pivot angle of the cam.

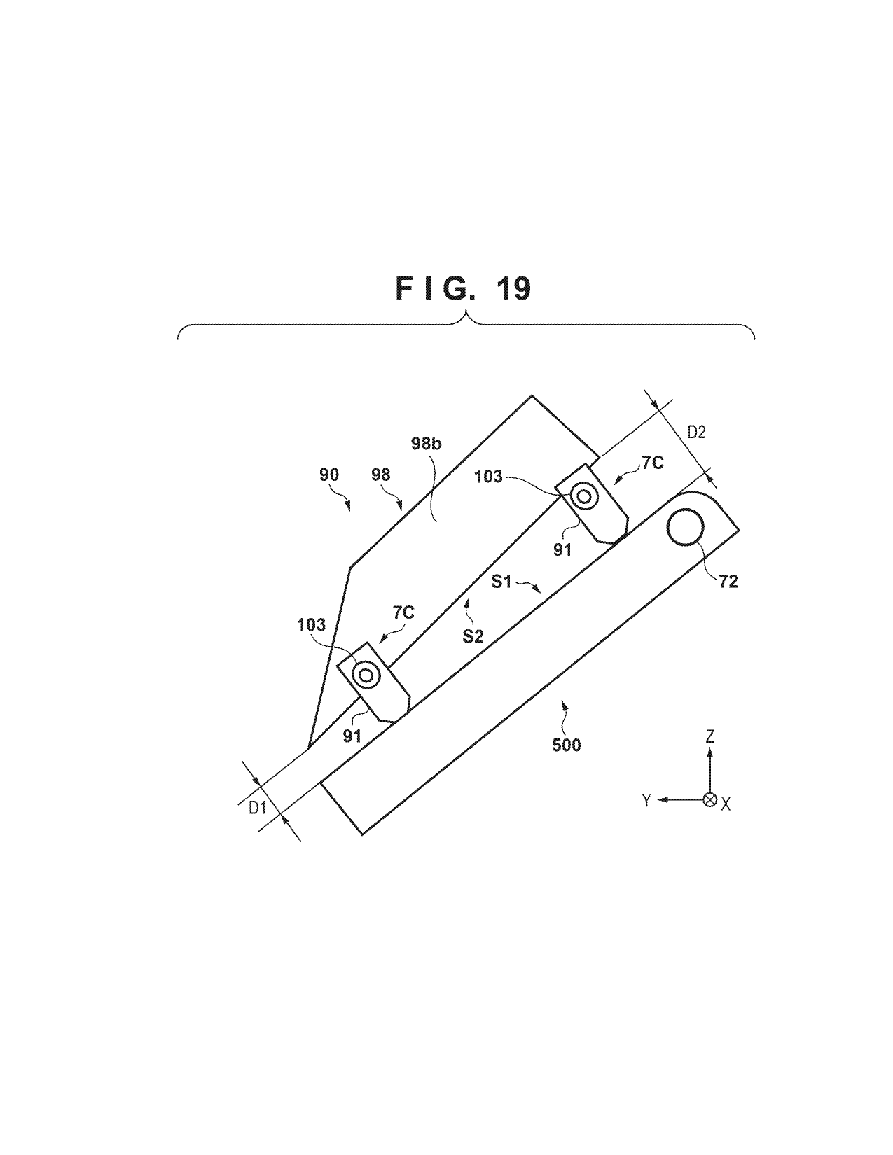

A plurality of sets of the support member 91 and the fixing member 103 are provided in the housing 98. The amount of displacement of the heating plate 94 relative to the guide surface S1 in the approaching-separation direction can be adjusted for each set of the support member 91 and the fixing member 103. This makes it possible to adjust the distance from the guide surface S1 at each area of the heating plate 94, even when the size of the heating plate 94 is relatively large. Additionally, for example, a distance D2 between the heating unit 90 on the upstream side and the guide surface S1 in the conveyance path of the sheet 1 can be adjusted to be wider than a distance D1 between the heating unit 90 on the downstream side and the guide surface S1, as illustrated in FIG. 19. A rise in temperature can be slowed by gradually narrowing the gap between the heating unit 90 and the guide surface S1 with progress toward the downstream side. This makes it possible to provide a temperature gradient from the upstream side to the downstream side of the heating unit 90.

Although the present embodiment has described the fixing position of the support member 91 and the housing 98 of the heating unit 90 as being adjustable, a mechanism that adjusts the distance between the guide surface S1 and the heating unit 90 using the spacer 81 may be used.

According to the present disclosure, a print medium can be heated uniformly.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-034027, filed Mar. 4, 2025 which is hereby incorporated by reference herein in its entirety.

What is claimed is:

1. A printing apparatus comprising:
a conveyance unit configured to convey a print medium on which printing was performed by a printing unit;
a guide unit configured to guide the print medium conveyed by the conveyance unit;
a heating unit disposed in a position opposing a guide surface of the guide unit, and configured to heat the print medium conveyed by the conveyance unit; and
an adjustment unit configured to adjust a distance between the guide surface and the heating unit,
wherein the guide unit includes a guide member that forms the guide surface, and
the adjustment unit adjusts a position of the guide member in an approaching-separation direction in which the guide member approaches and separates from the heating unit.

2. The printing apparatus according to claim 1,
wherein the guide unit includes a base member for supporting the guide member from a side opposite to a side on which the guide surface is located, and
the adjustment unit includes a support shaft configured to support the guide member relative to the base member such that the position of the guide member is displaceable in the approaching-separation direction.

3. The printing apparatus according to claim 2,
wherein the adjustment unit includes an elastic member provided between the guide member and the base member.

4. The printing apparatus according to claim 2,
wherein the support shaft passes through the guide member and is fixed to the base member.

5. The printing apparatus according to claim 2,
wherein a plurality of the support shaft are provided in the guide member, and
the position of the guide member in the approaching-separation direction is adjustable for each of the support shafts.

6. The printing apparatus according to claim 2,
wherein a plurality of the support shaft are provided in the guide member,
the guide surface has a plurality of recesses, and
leading end portions of the plurality of support shafts are respectively accommodated in the plurality of recesses.

7. The printing apparatus according to claim 6,
wherein the plurality of recesses are formed in the guide surface in a staggered pattern along a conveyance direction in which the print medium is conveyed by the conveyance unit.

8. The printing apparatus according to claim 2, further comprising:
a spacer that defines a gap between the base member and the heating unit.

9. The printing apparatus according to claim 1,
wherein the heating unit includes:
a heating element; and
a heating plate having an exhaust hole through which a gas heated by the heating element is dischargeable, and forming a heating surface that opposes the guide surface, and
the adjustment unit adjusts a position of the heating plate relative to the guide surface in the approaching-separation direction.

10. The printing apparatus according to claim 9,
wherein the heating unit includes a housing that forms a space accommodating the gas heated by the heating element and that supports the heating plate, and
the adjustment unit includes a fixing member that fixes the heating plate and the housing such that the heating plate is displaceable in the approaching-separation direction.

11. The printing apparatus according to claim 10,
wherein a plurality of the fixing member are provided in the housing, and
the heating plate is displaceable in the approaching-separation direction for each of the fixing members.

12. The printing apparatus according to claim 9,
wherein the heating unit includes a housing that forms a space accommodating the gas heated by the heating element and that supports the heating plate, and
the adjustment unit includes a support member that supports the housing to the guide unit, and a fixing member that fixes the support member and the housing such that the heating plate is displaceable in the approaching-separation direction.

13. The printing apparatus according to claim 12,
wherein the support member is a pivotable cam, and
an amount of displacement of the heating plate in the approaching-separation direction is adjusted according to a pivot angle of the cam.

14. The printing apparatus according to claim 12,
wherein a plurality of sets of the support member and the fixing member are provided in the housing, and
an amount of displacement of the heating plate in the approaching-separation direction is adjustable for each of the sets of the support member and the fixing member.

15. The printing apparatus according to claim 9,
wherein the heating plate is shaped such that a length in a direction intersecting a conveyance direction in which the print medium is conveyed by the conveyance unit is shorter than a length in the conveyance direction, and
the printing apparatus includes a reinforcement member extending in a short-side direction of the heating plate.
